(19) United States
(12) Patent Application Publication
(10) Pub. No.: US 2026/0061900 A1
(43) Pub. Date: Mar. 5, 2026

(54) ROTATING CAR SEAT

(71) Applicant: GRACO CHILDREN’S PRODUCTS INC., Atlanta, GA (US)

(72) Inventors: ADAM ANDREW MCKENZIE, Decatur, GA (US); PHILLIP MICHAEL LAPLANTE, Cumming, GA (US); PATRICK KIL, Atlanta, GA (US); ANDREW Q. LIU, Sandy Springs, GA (US)

(73) Assignee: GRACO CHILDREN’S PRODUCTS INC., Atlanta, GA (US)

(21) Appl. No.: 19/314,449

(22) Filed: Aug. 29, 2025

Related U.S. Application Data
(60) Provisional application No. 63/690,228, filed on Sep. 3, 2024.
(60) Provisional application No. 63/745,701, filed on Jan. 15, 2025.

(51) Int. Cl. B60N 2/28

(52) U.S. Cl. CPC B60N 2/2821; B60N 2/2863; B60N 2/2869

(57) ABSTRACT

An improved infant car seat (“ICS”) is provided. The ICS includes a base body and a turn table provided on the base body. The turn table is configured to receive a carrier of the ICS and rotate relative to the base body. Two different attachment points are provided to (1) lock the carrier into position on the base body to prevent rotation of the turn table and (2) to lock the carrier to the turn table as the turn table rotates relative to the base body. The ICS also includes grooves in the turn table. The grooves are sized and shaped to receive corresponding carrier rails provided on the bottom of the carrier such that the carrier can be slid onto and off of the turn table when the carrier is disengaged from both attachment points.

### CROSS-REFERENCE TO RELATED APPLICATIONS

This application claims priority to and benefit of U.S. provisional patent application No. 63/690,228 filed Sep. 3, 2024, and U.S. provisional patent application No. 63/745,701, filed Jan. 15, 2025, both of which are herein incorporated by reference in their entirety.

### TECHNICAL FIELD

The present disclosure relates to infant car seats (ICS) and more specifically to rotating car seats.

### BACKGROUND

Various automobile child safety seats have been developed to increase the safety of an infant or child (referred to generically as “child” hereinafter) as they ride in an automobile. These automobile child car safety seats are designed to be placed on the seat of the automobile. The conventional child car seats can be coupled to one of the automobile's passenger seat belt systems or via a LATCH (Lower Anchors and Tethers for Children) system to hold the child car seat in place along the top surface of the automobile seat. In addition, the child car seat can include its own harness restraint system (e.g., a 2-point, 3-point, 4-point, 5-point harness, etc.). Many features have been provided to improve the ergonomic aspects of using these child car seats. One ergonomic feature of existing child car seats is to make the car seat rotatable with respect to its seat base. However, conventional child safety seats may include elements that provide inconveniences for caretakers using the child safety seats. For example, conventional child safety seats may be configured such that the carrier needs to be “dropped” down into the base and removed from the base in an upward motion. This may be inconvenient for the caretaker if the vehicle is larger as it may be more difficult for the caretaker to add the carrier to the base and remove the carrier from the base.

### SUMMARY

In embodiments, the present disclosure describes a car seat. The car seat comprises a carrier, a base including a base body and a turn table configured to receive the carrier and rotate relative to the base body, one or more first attachment points provided on the base body, wherein the one or more first attachment points are configured to lock the carrier in a first position, and one or more second attachment points provided on the turn table, wherein the one or more second attachment points are configured to lock the carrier on the turn table as the turn table is rotated.

In embodiments, the present disclosure describes a car seat. The car seat comprises a carrier and a base including a base body and a turn table configured to receive the carrier and rotate relative to the base body, wherein the turn table includes one or more grooves, and wherein the carrier is configured to be slid through the one or more grooves of the turn table via one or more carrier rails.

In embodiments, the present disclosure describes a car seat. The car seat comprises a carrier, a base including a base body and a turn table configured to receive the carrier and rotate relative to the base body, and at least one of: (1) one or more first attachment points provided on the base body, wherein the one or more first attachment points are configured to lock the carrier in a first position or (2) one or more second attachment points provided on the turn table, wherein the one or more second attachment points are configured to lock the carrier on the turn table as the turn table is rotated.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1A shows a side view of a car seat in a locked position, in accordance with one or more embodiments of the disclosure.

FIG. 1B shows a perspective view of the car seat of FIG. 1A in a rotated position, in accordance with one or more embodiments of the disclosure.

FIG. 2A shows a perspective view of a base of the car seat of FIG. 1A, in accordance with one or more embodiments of the disclosure.

FIG. 2B shows a perspective view of the base of FIG. 2A with a turn table in a rotated position, in accordance with one or more embodiments of the disclosure.

FIG. 3A shows the carrier of the car seat of FIG. 1A, in accordance with one or more embodiments of the disclosure.

FIG. 3B shows a close-up view of the mechanism for actuating a front hook, in accordance with one or more embodiments of the disclosure.

FIG. 4 shows the turn table without the base of the car seat of FIG. 1A, in accordance with one or more embodiments of the disclosure.

FIG. 5 shows a transparent view of the turn table of FIG. 4, in accordance with one or more embodiments of the disclosure.

FIG. 6A shows a close-view view of the internal mechanisms of the turn table of FIG. 4, in accordance with one or more embodiments of the disclosure.

FIG. 6B shows another close-up view of the internal mechanisms of the turn table of FIG. 4, in accordance with one or more embodiments of the disclosure.

FIG. 6C shows a close-up view of the ramp of the turn table in a turned configuration, in accordance with one or more embodiments of the disclosure.

FIG. 7A shows a bottom-up view of the turn lock of the turn table of FIG. 6A, in accordance with one or more embodiments of the disclosure.

FIG. 7B shows an interaction between the ramp of FIG. 7A and a turn table pull link of the turn table, in accordance with one or more embodiments of the disclosure.

FIG. 8A-8D shows an exemplary process for removing a carrier from a car seat, in accordance with one or more embodiments of the disclosure.

FIG. 9A-9B shows another exemplary process from removing a carrier from a car seat, in accordance with one or more embodiments of the disclosure.

FIG. 10A-10B shows a mechanism for locking a carrier to a turn table, in accordance with one or more embodiments of the disclosure.

FIGS. 11A-11F show a close-up view of the first attachment point of the car seat of FIG. 1A, in accordance with one or more embodiments of the disclosure.

FIG. 11G shows the front hooks of the carrier engaged with the loops of the first attachment point of FIGS. 11A-11F, in accordance with one or more embodiments of the disclosure.

FIG. 12A shows a perspective view of another car seat in a rotated position, in accordance with one or more embodiments of the disclosure.

FIG. 12B shows a perspective view of the car seat of FIG. 12A in a locked position, in accordance with one or more embodiments of the disclosure.

FIG. 13A shows a top-down view of a carrier of the car seat of FIG. 12A, in accordance with one or more embodiments of the disclosure.

FIG. 13B shows a top-down close-up view of a front locking mechanism of the carrier of the car seat of FIG. 12A, in accordance with one or more embodiments of the disclosure.

FIG. 13C shows a top-down close-up view of a rear locking mechanism of the carrier of the car seat of FIG. 12A, in accordance with one or more embodiments of the disclosure.

FIG. 13D shows a close-up view of a rear portion of the carrier of the car seat of FIG. 12A, in accordance with one or more embodiments of the disclosure.

FIG. 13E shows a close-up perspective view of the rear portion of FIG. 13B, in accordance with one or more embodiments of the disclosure.

FIG. 14A shows a perspective view of a base of the car seat of FIG. 12A, in accordance with one or more embodiments of the disclosure.

FIG. 14B shows a top-down view of the base of FIG. 14A, in accordance with one or more embodiments of the disclosure.

FIG. 14C shows a perspective view of the base of FIG. 14A, in accordance with one or more embodiments of the disclosure.

FIG. 14D shows a rear view of a rotational mechanism for an attachment bar, in accordance with one or more embodiments of the disclosure.

FIG. 14E shows a perspective view of the rotational mechanism of FIG. 14D, in accordance with one or more embodiments of the disclosure.

FIG. 14F shows a close-up view of front attachment bar spring housings of the rotational mechanism of FIG. 14D, in accordance with one or more embodiments of the disclosure.

FIG. 15A shows a perspective view of the locking mechanisms of the car seat of FIG. 12A, in accordance with one or more embodiments of the disclosure.

FIG. 15B shows a top-down view of the locking mechanisms of the car seat of FIG. 12A, in accordance with one or more embodiments of the disclosure.

FIG. 15C shows a close-up view of a front locking mechanism without a housing, in accordance with one or more embodiments of the disclosure.

FIG. 15D shows a close-up view of the front locking mechanism of FIG. 16C with a housing, in accordance with one or more embodiments of the disclosure.

FIG. 15E shows a bottom-up view of the front locking mechanism of FIG. 16C, in accordance with one or more embodiments of the disclosure.

FIG. 15F shows a bottom-up view of a rear locking mechanism, in accordance with one or more embodiments of the disclosure.

FIG. 16A-16E show variations of front hooks of a carrier, in accordance with one or more embodiments of the disclosure.

FIGS. 17A-17C show a variation of the variation of the front mechanism housings and rear pull links, in accordance with one or more embodiments of the disclosure.

FIG. 18 shows a bottom-up view of a variation of a base, in accordance with one or more embodiments of the disclosure.

FIGS. 19A-19B show a close-up view of a variation of a base including an indicator element, in accordance with one or more embodiments of the disclosure.

FIGS. 20A-20F show a variation of a turn table, in accordance with one or more embodiments of the disclosure. The present disclosure provides a more detailed and specific description with reference to the accompanying drawings. The drawings and specific descriptions of the drawings, as well as any specific or other embodiments discussed, are intended to be read in conjunction with the entirety of this disclosure.

### DETAILED DESCRIPTION

Example embodiments will now be described more fully hereinafter with reference to the accompanying drawings, in which example embodiments are shown. The concepts disclosed herein may, however, be embodied in many different forms and should not be construed as limited to the example embodiments set forth herein; rather, these embodiments are provided so that this disclosure will be thorough and complete, and will fully convey the scope of the concepts to those skilled in the art. Like numbers refer to like, but not necessarily the same or identical elements throughout.

Described herein is an improved infant car seat (“ICS”) (also more generally referred to as a “car seat” herein). The car seat includes two major components: a carrier and a base configured to receive the carrier. Similar to some existing types of car seats, the carrier may be removably mounted onto the base, such that the carrier may be added to and detached from the base as desired. For example, a caretaker may attach the carrier to the base in the vehicle, provide an infant within the carrier, and then remove the infant from the carrier and the carrier from the base and the vehicle when the car seat is no longer in use. Reference is made herein specifically to a caretaker (for example, a caretaker of an infant who is provided in the car seat) for consistency, however, any other type of individual may also interact with the car seat.

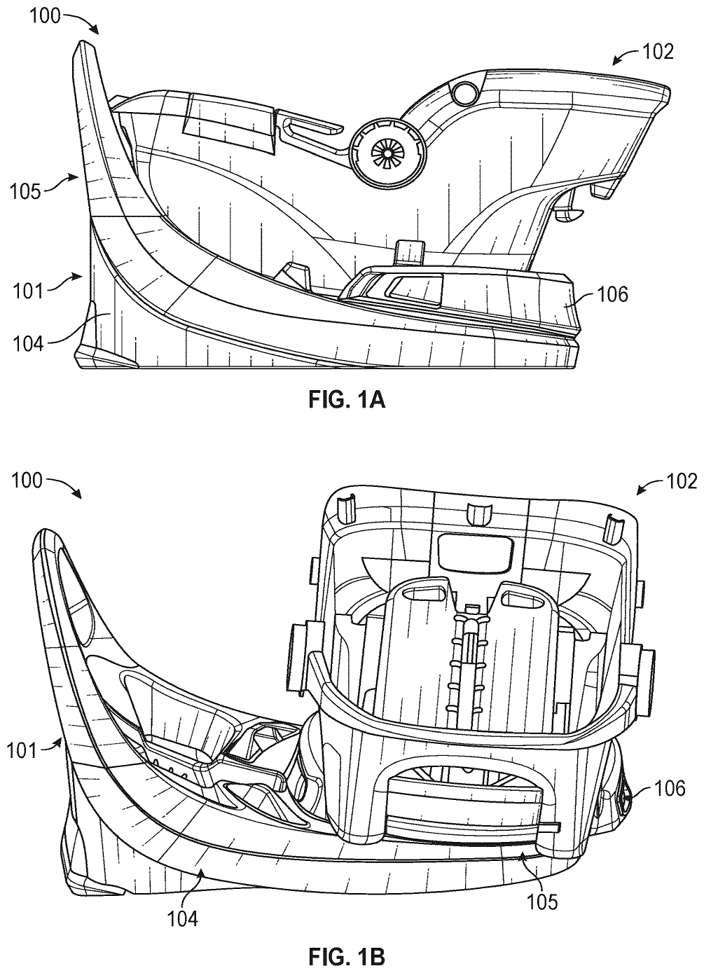

When describing the base and carrier, reference may be made to the “foot-end,” “head-end,” “midplane,” and “centerline.” The foot-end of the carrier may refer to the location of the carrier that is proximate to the anti-rebound bar (ARB) of the base (see FIGS. 1A-1B), which is the end of the carrier closest to the feet of the infant when the infant is placed in the carrier (and the carrier is rotated to the locked position). The head-end of the carrier may be located at the opposite end of the carrier that is closest to the head of the infant when the infant is placed in the carrier. The midplane may be an imaginary plane that runs through the center of the carrier. The centerline may be an imaginary plane that runs from the foot-end to the head-end of the car seat and creates two equal halves from a top-down perspective.

When describing the car seat as a whole, the term “locked position” may refer to the carrier being in an unrotated position (for example, shown in FIG. 1A). In the locked position, the carrier may be locked in place relative to the base of the car seat with the foot-end and head-end of the carrier aligned with the foot-end and head-end of the base. For example, the car seat may be in the locked position when the infant is in the car seat and the vehicle is in motion. The term “rotated position” may refer to a position in which the carrier is rotated relative to the base of the car seat (for example, shown in FIG. 1B). In the rotated position, the caretaker has easier access to the carrier for providing the infant in the carrier and removing the infant from the carrier (as well as removing the carrier from the base).

The car seat described herein also includes a turn table provided on the base, and the carrier may be specifically mounted on the turn table. The turn table is configured to rotate relative to the base (for example, the turn table may be rotated up to 90 degrees to the left or up to 90 degrees to the right, however, any other amount of rotation may also be possible and reference to 90 degrees is not intended to be limiting). Given that the turn table is configured to rotate both to the left and the right relative to the base, the foot end of the carrier may be rotated to face whichever vehicle door is closest to the car seat. This allows for the child to be more easily added to and removed from the car seat when the car seat is provided in the vehicle (and for the carrier to be removed from the base and the vehicle). An example of the car seat being rotated on the turn table is shown in FIG. 1B.

In embodiments, the turn table may remain in the rotated position without the turn table naturally rotating back to the locked position. Thus, when it is desired for the carrier to be loaded back into the vehicle, the turn table is already in the rotated position and ready to receive the carrier. This eliminates the extra step of requiring the caretaker to first turn the turn table before providing the carrier on the turn table and reduces the complexity of the process of adding the carrier to the car seat. Otherwise, the caretaker may need to place the carrier on the ground to turn the turn table, pick the carrier back up, and then provide the carrier on the turn table.

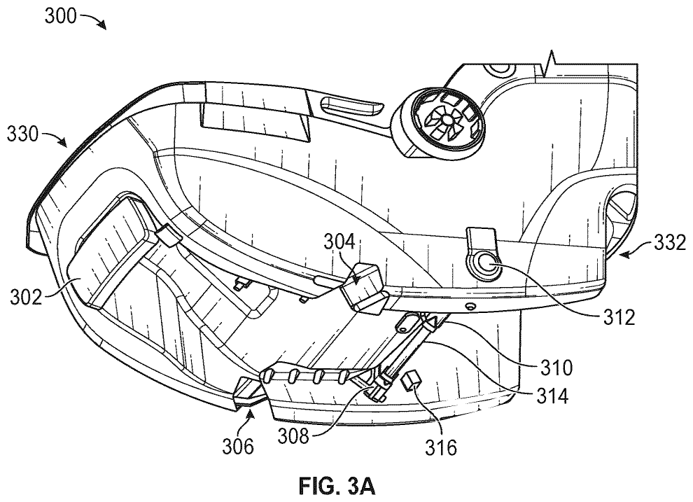

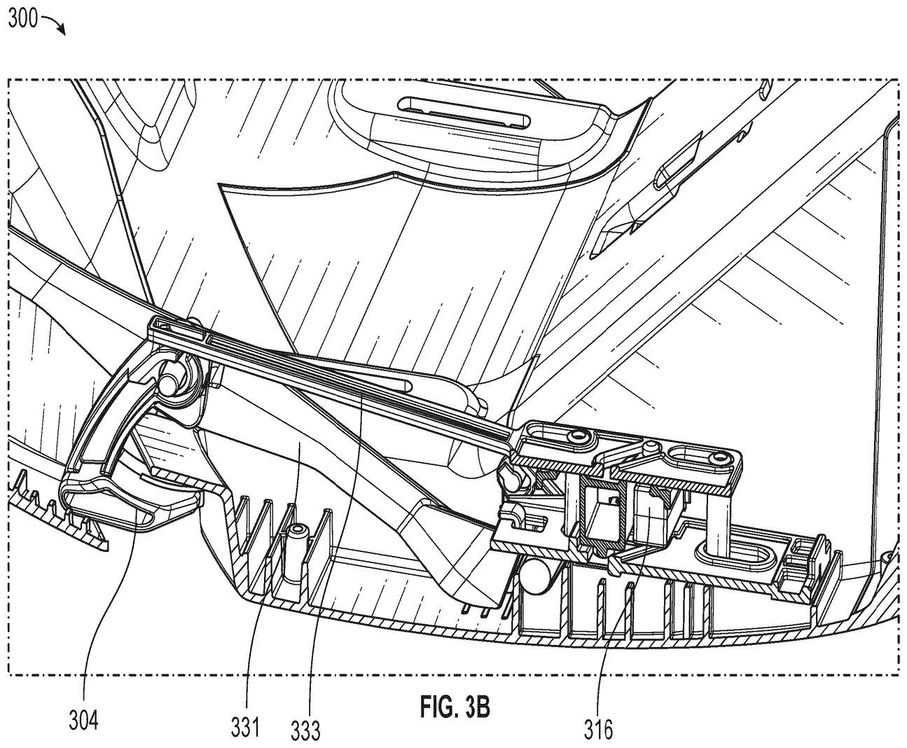

The car seat also improves over existing car seats by including grooves in the turn table. The grooves are sized and shaped to receive corresponding carrier rails provided on the bottom of the carrier (shown in FIG. 3A). When the carrier is provided on the turn table, the carrier rails slide within the corresponding grooves in the turn table. Accordingly, to remove the carrier from the base, the carrier may be rotated relative to the base via the turn table and the carrier may then be slid outwards from the car seat by sliding the carrier rails through the grooves. This allows the carrier to slide away from the center of the base and closer to the caretaker.

Conversely, when the caretaker needs to put the child back into the vehicle, the caretaker can set the carrier rails in the grooves of turn table, push the carrier back into the base (slide the carrier through the grooves via the carrier rails), and rotate the carrier from the rotated position in which the foot end of the carrier is facing the door of the vehicle to the locked position in which the foot end of the carrier is facing the seat of the vehicle (this locked position is visualized in FIG. 1A, for example). The grooves therefore assist the caretaker in loading and unloading the child from the car seat, as well as adding the carrier to the base and removing the carrier from the base.

Existing car seats typically include a ridge at the foot end of the base that prevents the carrier from sliding out from the base (or into the base). Thus, the carrier is added to the base of the car seat in a “dropping in” motion in these existing car seats. That is, the carrier is placed downwards into the base rather than the carrier being slid into the base. Likewise, to remove the carrier from the base, the carrier may need to be lifted upwards and out of the base rather than the carrier being slid horizontally out of the base. This results in a more difficult loading and unloading process for a caretaker, which is exacerbated in larger vehicles with greater ride heights (the caretaker would need to be able to lift the carrier to a greater height, rather than sliding the carrier out from the base).

The improved car seat described herein also advantageously includes several different attachment points (in some embodiments, two attachment points may be provided, however, other attachment points may also be provided in other embodiments as well) on the base to secure the carrier to the base. For example, a first attachment point may be provided on the base proximate to the foot end of the carrier and selectively locks the carrier into the locked position (to prevent rotation of the carrier until it is desired for the carrier to be rotated). As one non-limiting example, this first attachment point may include one or more “loops” provided on the base that are configured to receive corresponding front hooks on the carrier.

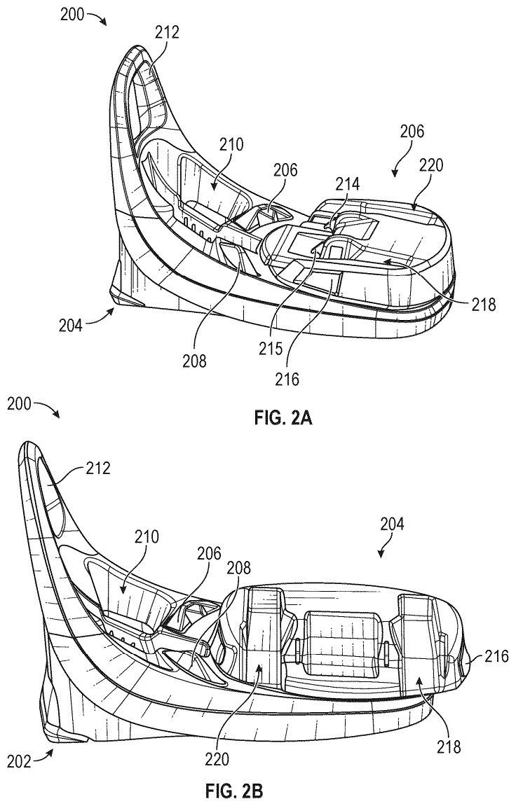

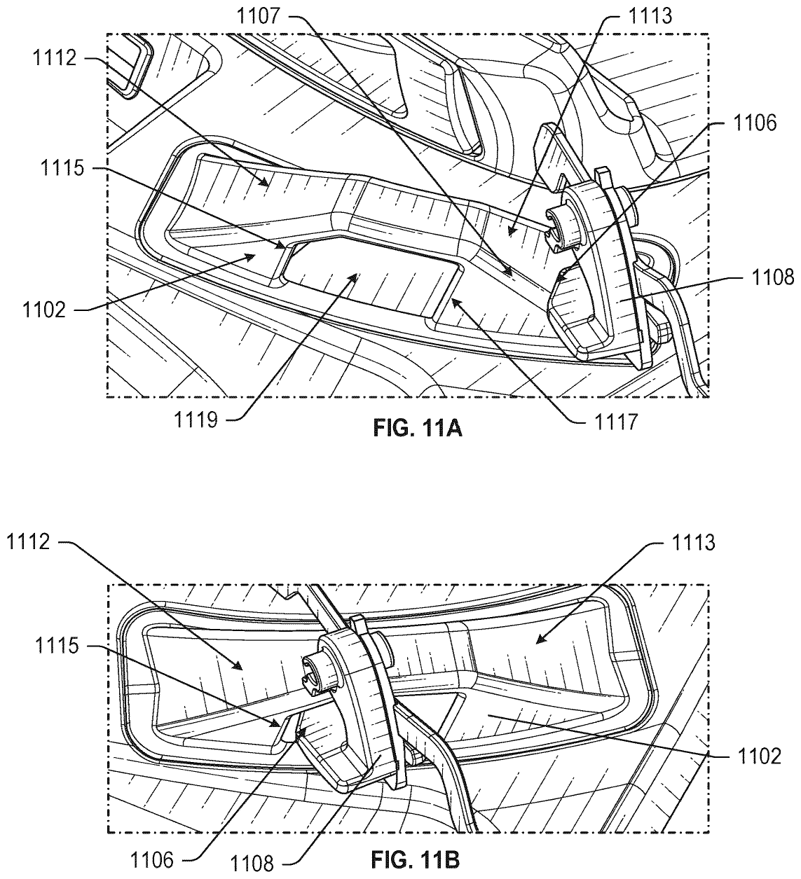

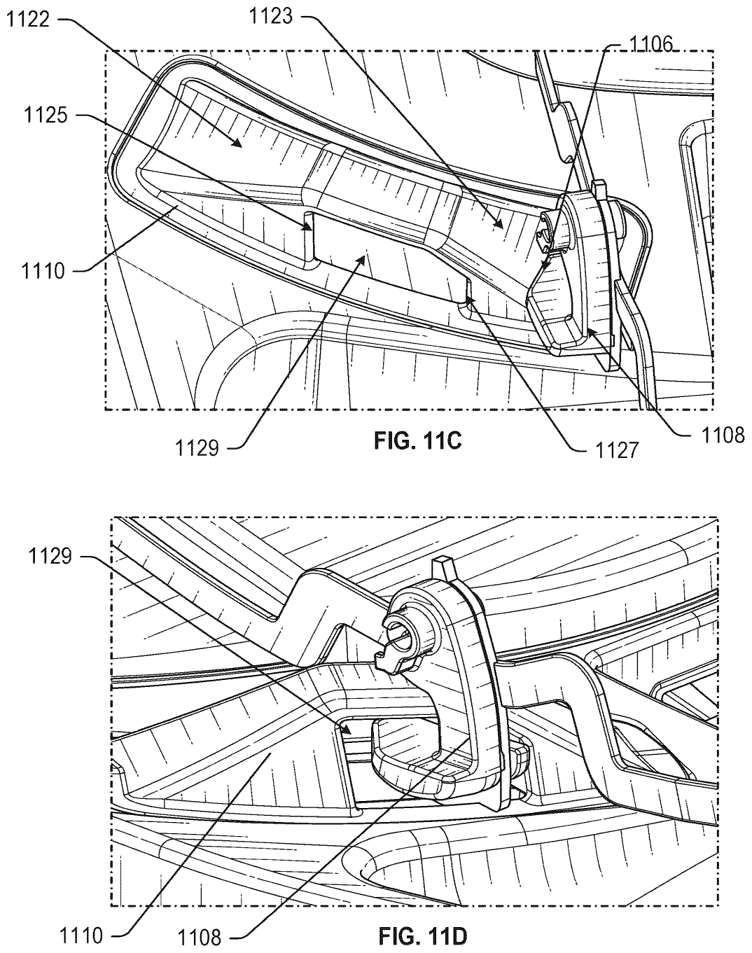

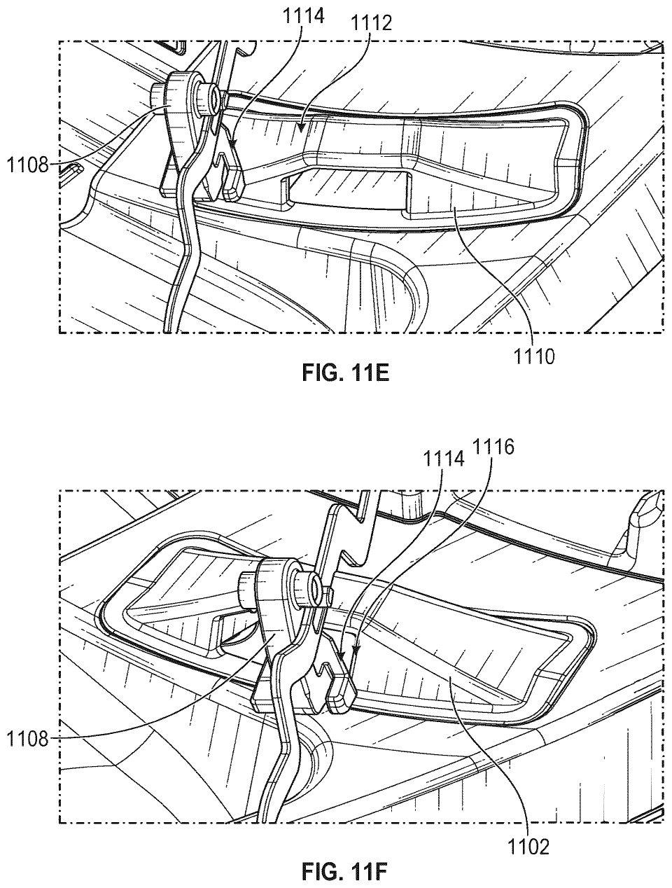

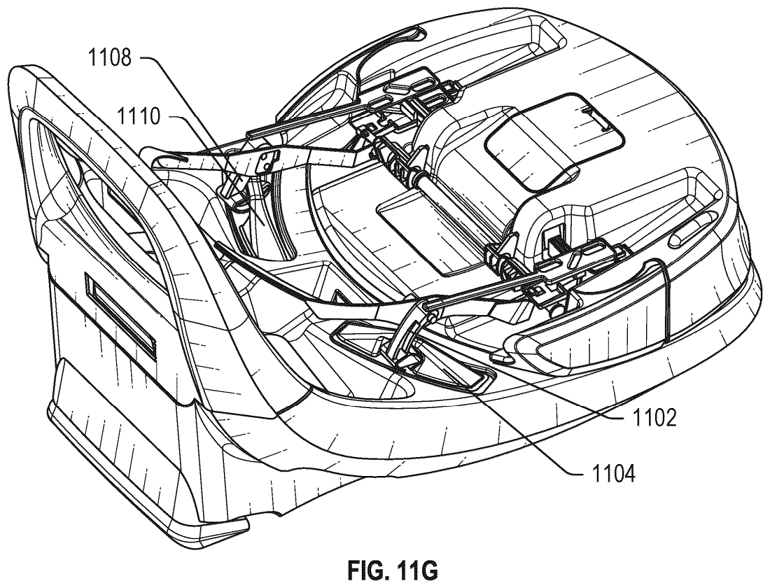

In embodiments, the one or more loops and the corresponding hooks may be configured such that as the carrier rotates, the first hook interacts with the second loop and slides past the second loop without locking into place in the second loop. For example, the loops may include ramped outer surfaces (and/or interior surfaces) and the hooks may also include ramped surfaces. Thus, the ramped surface of the first hook may slide along the ramped surfaces of the loop to allow the first hook to slide past the second loop. As the carrier continues to rotate, the first hook interacts and slides into place in the first loop and the second hook rotates and slides into place in the second loop. Although reference is made herein to the front hooks being provided on the carrier and the loops being provided on the base body, the opposite may also be true and the front hooks may be provided on the base body and the loops may be provided on the carrier (or a combination of the two). The mechanisms involved in this process are further illustrated in at least FIGS. 2A-2B and FIGS. 11A-11G.

A first actuator is also provided that allows for the carrier to disengage from the first attachment point to allow the carrier to then be rotated on the turn table. That is, the caretaker may actuate the first actuator, which causes the front hooks to disengage from the loops on the base, allowing the carrier to then be rotated relative to the base via the turn table. For example, the first actuator may cause the front hooks to rotate at least partially outwards from the cavities of the loops on the base, allowing the front hooks to interact with the loops in a manner that allows the front hooks to slide past the loops as the carrier is rotated. The first actuator may also cause any other change that allows the carrier to be rotated relative to the base depending on the type of mechanism that is used with the first attachment point.

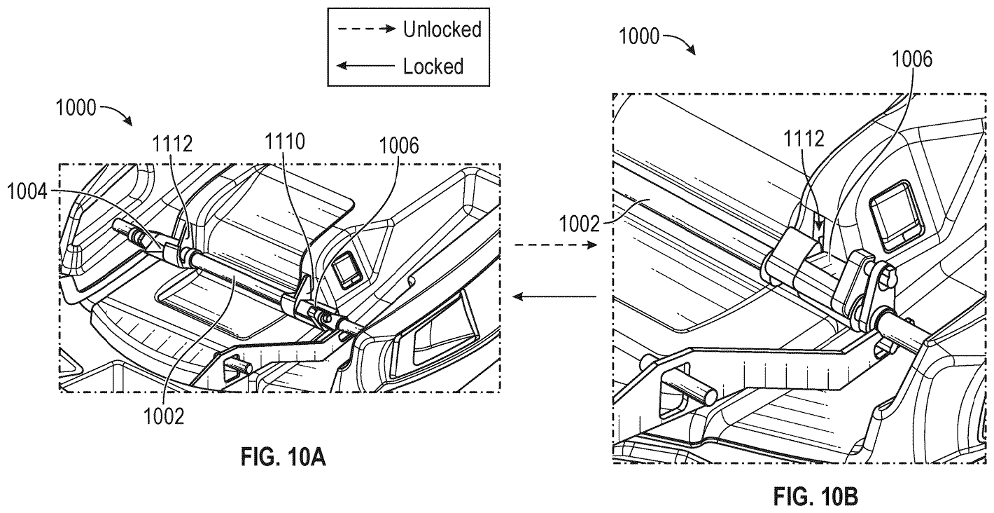

In embodiments, a second attachment point is also provided on the turn table that selectively locks the carrier onto the turn table. This second attachment point allows the carrier to be rotated relative to the base via the turn table while keeping the carrier attached to the turn table. The second attachment point also prevents the carrier from falling from the turn table when the first actuator is actuated to release the carrier from the first attachment point. As one non-limiting example, this second attachment point may include one or more retractable rear hooks provided on the turn table that are configured to snap over a corresponding rear bar on the bottom of the carrier (an example of this mechanism is shown in at least FIGS. 5 and 10A-10B).

A second actuator is also provided that allows for the carrier to disengage from the second attachment point to allow the carrier to then be removed from the base. That is, the caretaker may actuate the second actuator, which causes the rear bar to rotate and push the rear hooks into cavities located behind the rear hooks. This frees the rear bar from the rear hooks, allowing the carrier to then be removed from the turn table. The rear hooks may be spring-loaded such that they naturally return to their original position once the second actuator is released. The second actuator may also cause any other change that allows the carrier to be rotated relative to the base depending on the type of mechanism that is used with the second attachment point.

In some instances, the axis of rotation of the car seat may not necessarily be located under the center of gravity of the car seat. Instead, the axis of rotation may be located closer to the head-end of the carrier. During rotation of the carrier on the turn table (for example, after actuation of the first actuator described above), the off-center rotation moves the carrier further towards the door of the vehicle (and, in some instances, partially out of the door of the vehicle). A mechanism may also be provided on the turn table that may be actuated to allow the turn table to then be rotated relative to the base. Once the first actuator is actuated to release the carrier from the first attachment point and the mechanism is actuated to allow the turn table to rotate, the turn table and the carrier can be turned toward the caretaker. The carrier may still be attached to the turn table at the second attachment point at the back of the carrier. The caretaker may then actuate the second actuator to remove the carrier from the base and the vehicle. To remove the carrier from the base and the vehicle, the carrier may be slid through the grooves of the turn table.

When it is desired for the carrier to be added back to the car seat, the back edge of the carrier rails may be slid into the corresponding grooves in the turn table. The carrier may then be pushed back towards the second attachment point (for example, the rear hooks on the turn table, as shown in FIGS. 10A-10B) to secure the carrier to the turn table. For example, the carrier may be pushed back through the grooves until the hooks on the turn table engage with the bar on the carrier.

With the hooks securing the carrier to the turn table in the rotated position, the carrier may be rotated back into the locked position. As the carrier is rotated, the carrier may engage with the first attachment point on the base such that the carrier may then be locked to the base in the locked position. That is, the front hooks at the foot end of the carrier may engage with the loops on the base. In embodiments in which two front hooks are provided on the carrier and two loops are provided on the base, the second front hook on the carrier may be chamfered to move out of the way as the second front hook slides past the first loop but may engage with the second loop (preventing the second front hook from engaging with the first loop on the base).

The improved car seat described herein may also be used as a traditional car seat. The actuator at the foot end of the carrier may acuate the front hooks and push the rear hooks out of the way. That actuator may be accessible when the carrier is in the locked position. This allows the caretaker to lift the car seat off the base without rotating the turn table. The caretaker may also be able to drop the carrier into position when the base is in the locked position. Chamfers on the bottom of the carrier hooks and rear hooks allow them to be pushed out of the way and then sprung into a locked position when the carrier is seated.

Examples of variations of the car seat are described below with respect to the figures.

Turning to the figures, FIG. 1A shows a side view of a car seat 100. The car seat 100 includes a carrier 102 and a base 101 configured to receive the carrier 102. When it is desired for the car seat 100 to be used, the carrier 102 is provided on the base 101 within the vehicle. Likewise, when it is no longer desired for the car seat 100 to be used (for example, if the caretaker wants to remove the infant from the vehicle in the carrier), the carrier 102 may be removed from the base 101. The base 101 may also be removed from the vehicle and stored and/or the carrier 102 may also remain on the base 101 within the vehicle even when not in use.

The base 101 includes a base body 104 and a turn table 106. The base body 104 is the portion of the car seat 100 that supports the other components of the car seat 100 and may be provided on the seat of the vehicle (not shown in the figure). The base body 104 may include at least some standard components of a car seat, such as vehicle belt attachment features, lock-off features, an optional ARB, leveling features, and/or level indication features (these elements are shown in greater detail in at least FIGS. 2A-2B). Some or all of these elements may also be provided on the turn table 106 as well.

The turn table 106 may be located on the base body 104 and is configured to rotate relative to the base body 104. The rotation of the turn table 106 may be performed using any suitable mechanism known in the art. Exemplary mechanisms may be found in at least U.S. Pat. No. 11,884,188, which is incorporated herein by reference. While reference is made to the carrier 102 being provided on the base 101, the carrier 102 may more specifically be provided on the turn table 106 of the base 101 (however, some elements of the carrier 102 may also come into contact with the base 101, or elements provided on the base 101, such as the first attachment point). Accordingly, when the car seat 100 is fully assembled with the base 101 and the carrier 102, the carrier 102 can be rotated relative to the base body 104 by rotating the turn table 106.

As indicated above, the turn table 106 may be rotated up to 90 degrees to the left or up to 90 degrees to the right, however, any other amount of rotation may also be possible. The turn table 106 may also be configured to rotate in other directions as well. Given that the turn table 106 is configured to rotate both to the left and the right relative to the base body 104, the foot end 105 of the carrier 102 may be rotated to face whichever vehicle door is closest to the car seat. FIG. 1A shows the carrier 102 in a locked position in which the foot end 105 of the carrier 102 is facing the seat of the vehicle. FIG. 1B shows the carrier 102 in a rotated position in which the foot end 105 of the carrier 102 is facing a door of the vehicle (the vehicle is not shown in the figure).

FIG. 2A shows a perspective view of a base 200 (which may be the same as the base 101 or any other base described herein) with the carrier removed (such that only the base body 204 and the turn table 207 are visible). FIG. 2A shows the turn table 207 in a locked position and FIG. 2B shows the turn table 207 in a rotated position.

FIG. 2A illustrates some of the components of the base body 204 and the turn table 207, such as the attachment points and actuation mechanisms described above. For example, the base body 204 is shown as including a first attachment point. As previously indicated, the first attachment point is configured to engage with the foot end of the carrier (not shown in the figure) when the carrier is provided in the locked position on the base 200, thus allowing the carrier to be locked into the locked position when the car seat is in use. Although the first attachment point is shown as being provided on the base body 204, the first attachment point may also be provided on the turn table as well.

In some embodiments, the first attachment point may include a first loop 206 and a second loop 208. While two loops are shown in FIG. 2A, the first attachment point may also include any other number of loops (including one loop or more than two loops). Additionally, the loops may also be provided in any other sizes or shapes and any other positions in the base body 204. The loops may be configured to receive corresponding front hooks provided on the carrier when the carrier is rotated to the locked position. An example illustration of the interaction that occurs between the front hooks on the carrier and the loops on the base body 204 is shown in at least FIGS. 11A-11D. Any of the hooks described herein may be configured as traditional hook shapes, latches, multi-hook hasps, etc. The hooks and loops may be made from any material, such as plastics, metal, etc.

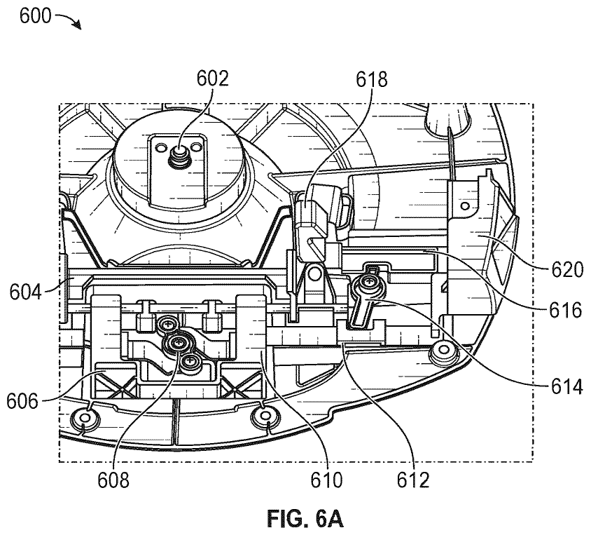

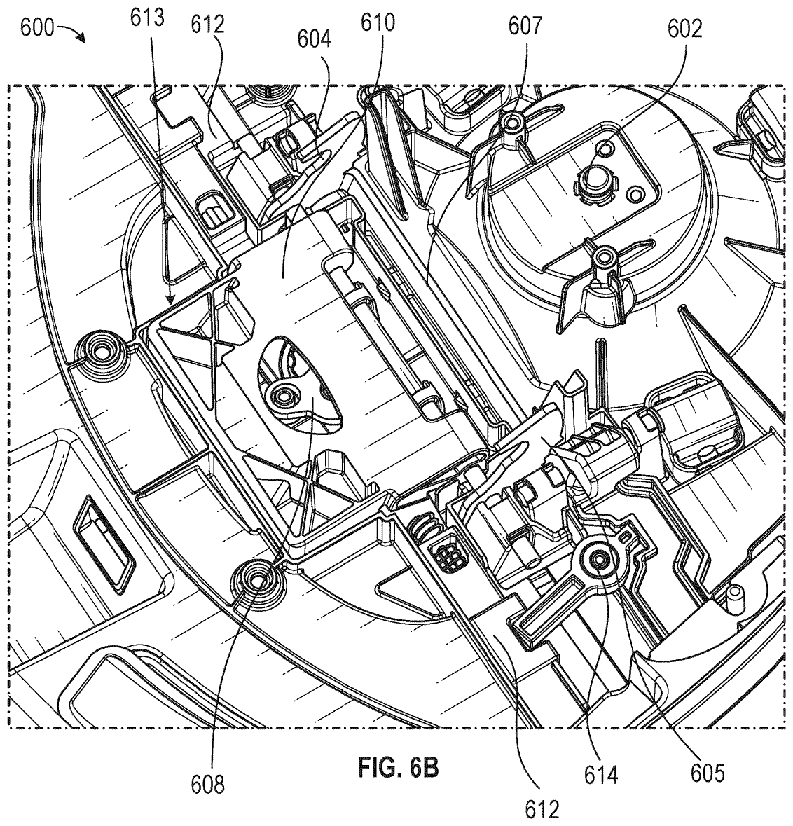

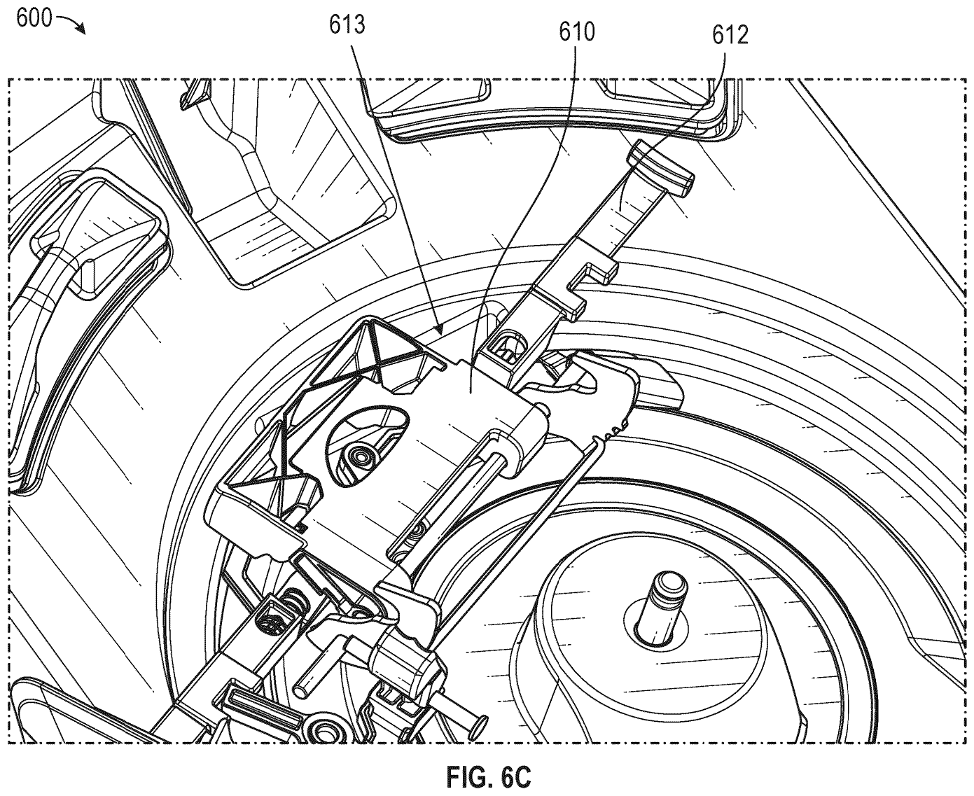

The base body 204 is also shown as including the second attachment point. As previously indicated, the second attachment point provides another point of engagement with the carrier to allow the carrier to remain secured to the turn table 207 as the turn table 207 is rotated relative to the base body 204. Specifically, the second attachment point includes a first rear hook 214 and a second rear hook 215. While two rear hooks are shown in FIG. 2A, the second attachment point may also include any other number of rear hooks. Additionally, as shown in the figure, even though “two” rear hooks are shown, the hooks may be connected together to form a single structure such that the rear hooks are actuated in the same manner. For example, at least FIG. 6B more clearly depicts rear hooks 604 and 605 connected by bar 607 to form a single, continuous structure. Further, the rear hooks may also be provided in any other sizes or shapes and any other positions in the turn table 207.

In embodiments, the rear hooks are configured to engage with a bar provided on the carrier to lock the carrier to the turn table 207. A mechanism is provided that, when actuated, causes the rear hooks to disengage from the bar on the carrier to allow the carrier to then be removed from the turn table 207. An example illustration of the mechanisms used to engage and disengage the second attachment point is provided in FIGS. 10A-10B. Additionally, an example illustration of the engagement between the bar on the carrier and the hooks on the turn table 207 is shown in at least FIGS. 10A-10B.

While the first attachment point is described herein as specifically including loops configured to receive the front hooks on the carrier, this is merely one exemplary mechanism by which the carrier may be locked in the locked position on the base body 204 and other mechanism may also be possible. Likewise, any other mechanism may be used as the second attachment point as well.

FIGS. 2A-2B also shows that the base body 202 may include a belt path 210, a turn table actuator 216, an ARB 212, and/or any other components of a standard car seat. Other elements found on existing types of car seats may also be included as well.

FIGS. 3A-3B show an exemplary carrier 300 (for example, the carrier 300 may be the same as, or similar to, carrier 102 or any other carrier described herein or otherwise) that is removed from the base of the car seat (that is, the base is not shown in FIGS. 3A-3B). FIGS. 3A-3B shows exemplary components of a carrier in more detail.

In embodiments, the carrier 300 may include components used to engage with and disengage from the first attachment point on the base of the car seat. For example, the carrier 300 may include a front actuator 302 and one or more front hooks (for example, front hook 304, front hook 306, and/or any other number of front hooks). The one or more front hooks 304 and 306 may be the same as, or similar to the front hooks described with respect to FIGS. 2A-2B or any other front hooks described herein or otherwise). The one or more front hooks may be located in the carrier rails in some embodiments, however, the one or more front hooks may also be provided at any other location on the carrier 300. As previously indicated, the one or more front hooks may engage with corresponding loops on the base body of the car seat to lock the carrier in the locked position on the base.

The carrier 300 may also include components used to engage with the second attachment point on the turn table of the car seat. For example, the carrier 300 may include a rear bar 314 with attached hook pushers (for example, hook pusher 308, hook pusher 310, and/or any other number of hook pushers), one or more stroller plungers 312, a stroller hook (not shown in the figure), passthrough button(s) (for example, passthrough button 316), and all the internal mechanisms used to achieve the operation of the car seat as described herein. The operation of these components is shown in further detail in FIGS. 10A-10B.

When the front actuator 302 is actuated, the front hooks 304 and 306 rotate up and toward the foot-end 330 of the carrier 300, the hook pushers 308 and 310 and rear bar 314 rotate toward the head-end 332 of the carrier 300, the stroller plungers 312 then retract, and the stroller hook actuates. All these components may be spring loaded so when the actuator 302 is released, they return to their locked position. The front actuator 302 may be actuated, for example, by squeezing the front actuator 302 upwards. However, the front actuator 302 may also be configured to be actuated in any other manner.

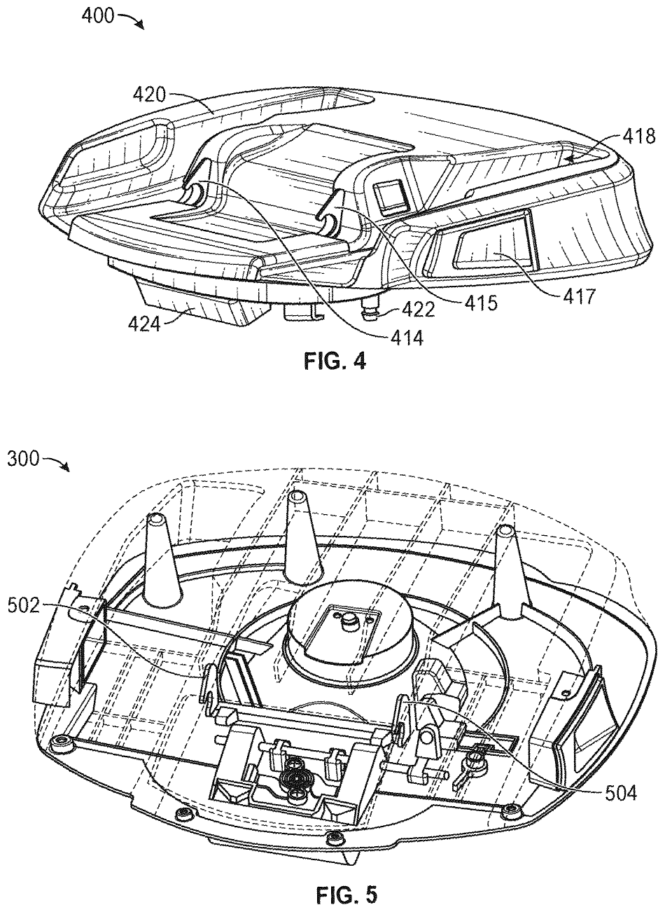

FIG. 4 shows an exemplary turn table 400 (which may be the same as, or similar to, any other turn table described herein or otherwise) that is removed from the base body of the car seat. FIG. 5 shows a transparent view of the turn table 400 of FIG. 4 such that at least some of the internal components of the turn table 400 are visible. Particularly, FIG. 4 shows the one or more grooves (for example, first groove 418 and second groove 420), a turn lock 424 (which may be the same as, or similar to, turn lock 610 or any other turn lock described herein), a kingpin 422 (which may be the same, or similar to, as kingpin 602 or any other kingpin described herein), an actuator 417 (which may be the same as, or similar to, turn table actuator 216 and/or any other turn table actuator described herein), and the second attachment point (for example, including the one or more rear hooks including the first rear hook 414 and the second rear hook 415, which may be the same as, or similar to, any other rear hooks described herein).

FIGS. 6A-6C shows a close-up view of the internal mechanisms of a turn table 600 (which may be the same as, or similar to, turn table 106, turn table 207, turn table 400, and/or any other turn tables described herein or otherwise). Specifically, FIGS. 6A-6C illustrate exemplary mechanisms that may be used to actuate at least the second attachment point of the car seat (as well as any other mechanisms that may be provided in the turn table). Reference is made below to elements from both FIGS. 3 and 6A-6C to describe the interaction between components of the carrier 300 and the turn table 600.

In embodiments, the turn table 600 may include a turn table actuator 620 (which may be a different actuator than the front actuator 302 of the carrier 300 shown in FIGS. 3A-3B). Actuation of the turn table actuator 620 allows the turn table 600 to rotate relative to the base (not shown in the figure). Otherwise, the carrier is locked into the first attachment point on the base body, thus preventing rotation of the turn table 600 (given that the turn table 600 is engaged with the carrier). For example, the turn table actuator 620 may include a hinge and may be actuated by pulling one side of the turn table actuator 620 outward (similar to the functionality of a conventional car door). However, the turn table actuator 620 may also be actuated in any other suitable manner.

Specifically, actuation of the turn table actuator 620 causes a turn lock 610 on the turn table 600 to be pulled upward out of a locked position within a divot 613 in which the turn lock 610 naturally rests. The turn lock 610 is a feature that, when actuated, allows the turn table 600 to turn, but otherwise may be spring loaded to fall into a locked position when the turn table 600 is in the locked position.

After the turn lock 610 is actuated and the turn table 600 is partially rotated, the turn lock 610 may be prevented from falling back into a locked position, so the caretaker does not have to continually hold the turn table actuator 620 to fully rotate the carrier (not shown in the figure) and the turn table 600. This is because the turn lock 610 is actuated out of the divot 613 in the base body in which the turn lock 610 naturally rests (e.g., when the carrier is in the locked position) and is rotated away from the divot 613, as shown in FIG. 6C. Given that the turn lock 610 is no longer located over the divot 613, the turn lock 610 is prevented from returning downward into its initial resting position (until the turn table is rotated such that the turn lock 610 again aligns with the divot 613).

Passthrough arms may be configured to push on the carrier passthrough buttons 316 when the carrier 300 is on the base (for example, as shown in FIGS. 1A-1B). Pressing the passthrough buttons 316 releases the front hooks (for example, front hooks 304 and 306) from the loops (for example, loops 206 and 208 shown in FIGS. 2A-2B) and allows the carrier 300 and turn table 600 to turn. That is, the actuation of the turn table actuator 620 ultimately results in the carrier 300 being disengaged from the first attachment point of the base, allowing the carrier 300 to then be rotated relative to the base via rotation of the turn table 600.

Rear hooks 604 and 605 (which may be the same as, or similar to, any other rear hooks described herein or otherwise) may also be provided on the turn table 600 (shown in further detail in FIGS. 10A-10B). The rear hooks 604 and 605 may be spring loaded such that if the rear hooks 604 and 605 are pressed in and released, the rear hooks 604 and 605 naturally snap back out. A kingpin 602 may be provided that connects the turn table 600 to the base body and creates the axis of rotation. The axis of rotation sits between the midplane and the head-end of the car seat, for example. This off-center rotation causes the carrier 300 to swing closer to the door of the vehicle such that a user (such as a caretaker) has easier access to a child in the car seat from outside the vehicle.

The mechanism for inserting the carrier 300 onto the base of the car seat (for example, car seat 100 and/or any other car seat described herein) is described below. Reference is made to elements shown in FIGS. 3 and 6-7, however, the same description may be applicable to like elements shown in any of the other figures as well.

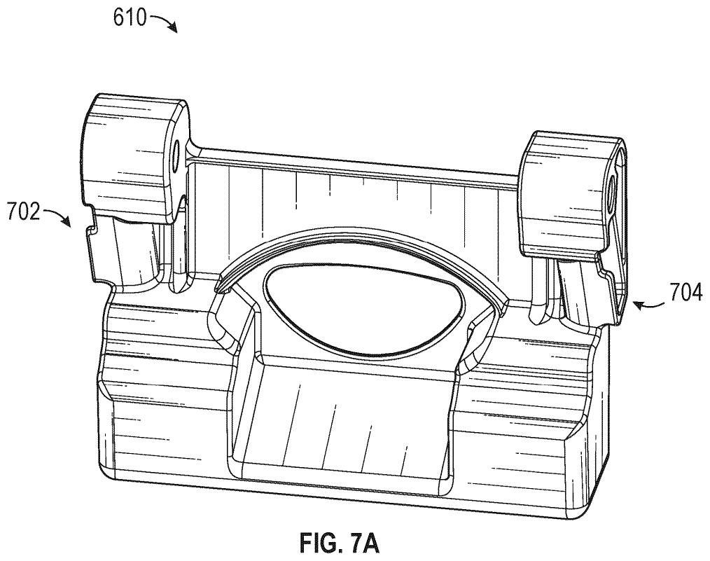

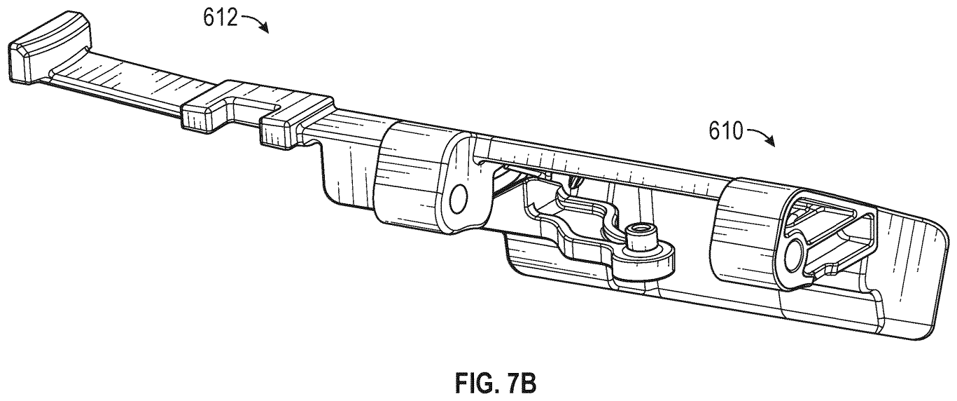

The process begins with the carrier 300 on the base in the unrotated, locked position (for example, illustrated in FIG. 1A). When the turn table actuator 620 is actuated, the turn table actuator 620 pulls on the turn table pull link(s) 612. The turn table pull link(s) 612 are mirrored inside the turn table 600 to the turn table actuator 620 on the other side and the turn table pull link(s) 612 are connected in the middle by a three-pin bar 608 (while reference is made specifically to a three-pin bar, this is not intended to be limiting and any other number of pins may also be used). The three-pin bar 608 ensures that when one turn table pull link 612 is pulled, the other is equally and oppositely pulled. Ramps on top of the turn table pull link(s) 612 push against ramps on the bottom of the turn lock 610 (a bottom view of the turn lock 610 including ramps 702 and 704 is shown in FIG. 7A and the interaction between the turn lock 610 and one turn table pull link 612 is shown in FIG. 7B), pushing the turn lock 610 up and out of the locked position from the divot 613 in the turn table 600. At the same time, passthrough toggles 614 attached to the turn table pull link(s) 612 translate linear motion in one direction into linear motion in the opposite direction.

While reference is made herein to various types of “links” (e.g., the turn table pull link 612, etc.), any other suitable mechanisms may also be used, such as tension cables.

The other ends of the toggles 614 are connected to passthrough slides 616. The passthrough slides 616 slide parallel and opposite to the turn table pull link(s) 612. The ends of the passthrough slides 616 are attached to the bottom of the passthrough arms (e.g., passthrough arm 618 and any other passthrough arms). The passthrough arms are hinged above the connection to the passthrough slides 616, pushing the top surface of the passthrough arms outward in the same direction as the motion of the turn table pull link(s) 612. The passthrough arms reach the inside of the carrier rails 340 and 342 and press the carrier passthrough button 316.

As the passthrough button 316 depresses, a boss of the passthrough button 316 rides in a sloped surface on a rear pull link 333 (shown in FIG. 3B), moving the rear pull link 333 toward the head-end of the carrier 300. As the push link 333 moves, the push link 333 rotates the front hooks 304 and 306 (which may be the same as, or similar to, any other front hooks described herein or otherwise) toward the foot-end of the carrier and releases the front hooks 304 and 306 from the first attachment point (for example, loops 206 and 208 shown in FIGS. 2A-2B) on the base body.

At this point, the caretaker may begin to rotate the carrier 300 and turn table 600 so that the foot-end of the carrier 300 begins to face the caretaker. This is possible because the front hooks 304 and 306 and turn lock 610 are retracted so there is no mechanism preventing the rotation of the carrier 300 and the turn table 600. Once rotation has begun, the base body prevents the turn lock 610 from dropping back into a locked position and interacting chamfers on the front hooks and the front attachments (for example, loops 206 and 208 shown in FIGS. 2A-2B) hold and/or push the front hooks 304 and 306 out of the locked position. The carrier 300 can then be rotated 90 degrees (for example, as shown in FIG. 1B). At 90 degrees of rotation, the carrier actuator 302 may be facing the caretaker, and the carrier 300 may be retained to the base by the interaction of the rear hooks 604 and 605 and the rear bar 314 of the carrier 300. The motion of the pull link 331 rotates the front hooks 304 and 306 toward the foot-end of the carrier 300 and rotates the rear bar 314 toward the head-end of the carrier 300. The head-end rotation of the rear bar 314 also rotates the integrally attached hook pushers 308 and 310. The hook pusher 308 and 310 push the rear hooks 604 off the rear bar 314 and the carrier 300 is free to be removed from the base.

The caretaker may simply lift the carrier 300 at this point and walk away, however, the turn table 600 has grooves 218 and 220 that allow the carrier rails 340 and 342 to slide out and offer support to the rear of the carrier 300 as it is being removed from the vehicle. This allows for the carrier 300 to be removed from the base in a more ergonomic motion.

When the caretaker is ready to put the carrier back into the vehicle, the turn table 600 may already be in the turned position. The caretaker can either place the carrier rails 340 and 342 on the grooves 218 and 220 and slide the carrier 300 back into the rear hooks 604, or the caretaker can place the carrier 300 directly over its locked position on the turn table 600 and drop the carrier 300 onto the rear hooks 604 and 605. Either way, the rear bar 314 may push the rear hooks 604 and 605 a sufficient distance such that the carrier 300 may be locked into the locked position.

Once the carrier 300 is in the turned locked position, the rear hooks 604 and 605 automatically snap over the rear bar 314. This turned locked position ensures that the front hooks 304 and 306 are aligned with the front attachments (for example, loops 206 and 208 shown in FIGS. 2A-2B) when rotating. The same chamfer surfaces that were described in turning the carrier 300 out, work to push the front hooks 304 and 306 out of the way or hold them out of the way as the carrier rotates to the locked position. When the carrier 300 and turn table 600 reach the locked position, the front hooks and turn lock articulate into place and the seat is locked.

The mechanism for drop-in installations begins with the carrier 300 on the base in the riding, locked position (for example, shown in FIG. 1A). When the caretaker actuates the carrier actuator 302, a carrier pull link 331 is pulled toward the foot end of the carrier 300. The carrier pull link 331 is attached to the front hook 304 and 306 and to a lever on the end of the rear bar 314. The motion of the carrier pull link 331 rotates the front hook 304 and 306 toward the foot-end of the carrier 300 and off the front attachment (for example, loops 206 and 208 shown in FIGS. 2A-2B) and rotates the rear bar 314 toward the head-end of the carrier 300. The head-end rotation of the rear bar 314 also rotates the integrally attached hook pushers 308 and 310. The hook pusher 308 and 310 push the rear hooks 604 off the rear bar 314 and the carrier 300 is free to be removed from the base.

Reinstalling the carrier 300 onto the base may involve the turn table 600 being in the locked position. The carrier 300 is aligned above the base 600 close to the locked position and is guided into place. The chamfers on the front hooks 304 and 306 and rear hooks 604 allow them to be pushed out of the way by the front attachments (for example, loops 206 and 208 shown in FIGS. 2A-2B), and the rear bar 314, respectively. Once the carrier is fully in place both the front hooks 304 and 306 and rear hooks 604 automatically snap into place locking the carrier down.

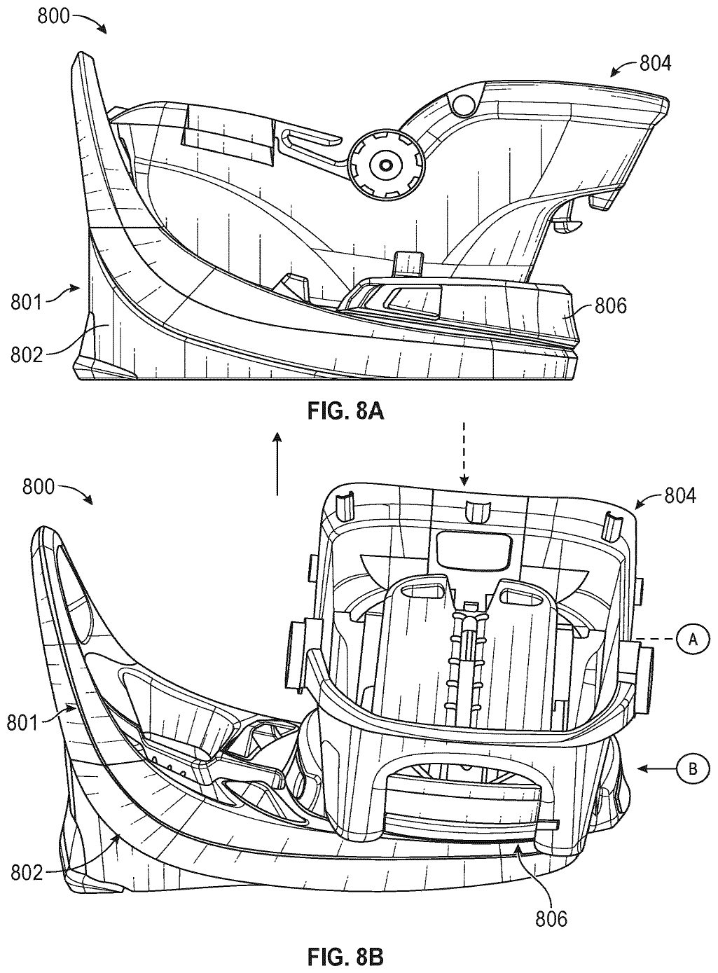

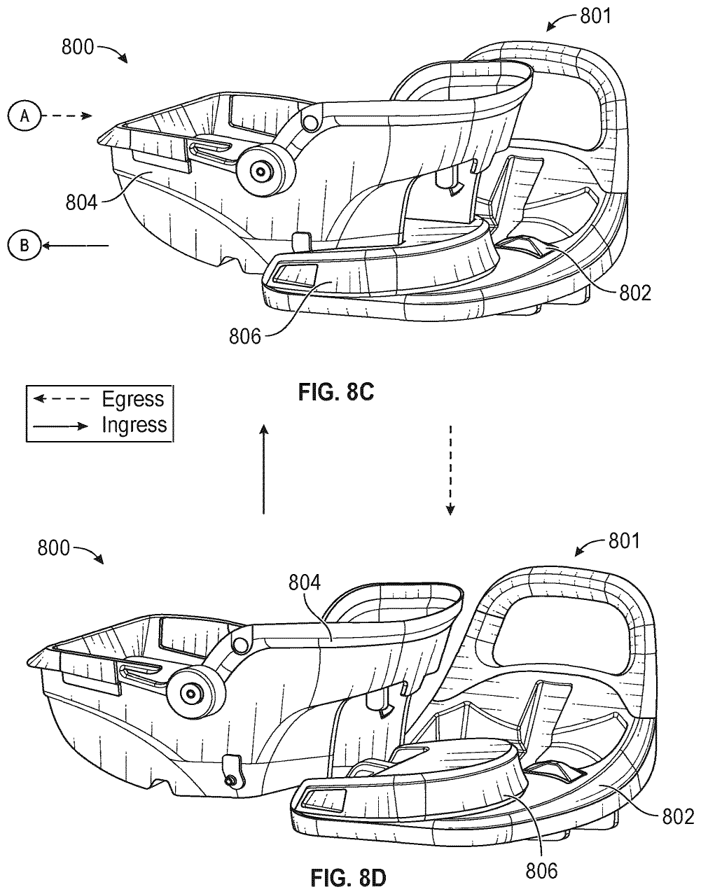

FIG. 8A-8D shows exemplary processes for removing a carrier 804 from a base 801 of a car seat 800 and returning the carrier 804 back to the base 801 of the car seat 800. Beginning with the process of removing the carrier 804 from the base 801, FIG. 8A shows the carrier 804 on the base 801 in a locked position FIG. 8B shows the carrier 804 rotated to the rotated position (that is, the turn table 806 is rotated relative to the base body 802). Finally, FIG. 8C shows the carrier 804 being slid from the turn table 806 (and the base) by sliding the carrier 804 through the grooves on the turn table. Finally, FIG. 8D shows the carrier 804 removed from the turn table 806. To add the carrier 804 to the base 801, the reverse process is performed. That is, the carrier 804 may be slid onto the turn table 806 by sliding the carrier rails of the carrier through the grooves of the turn table 806. The turn table 806 is then rotated until the carrier engages with the first attachment point on the base and the carrier is locked in the locked position on the base 801 (shown in FIG. 8A).

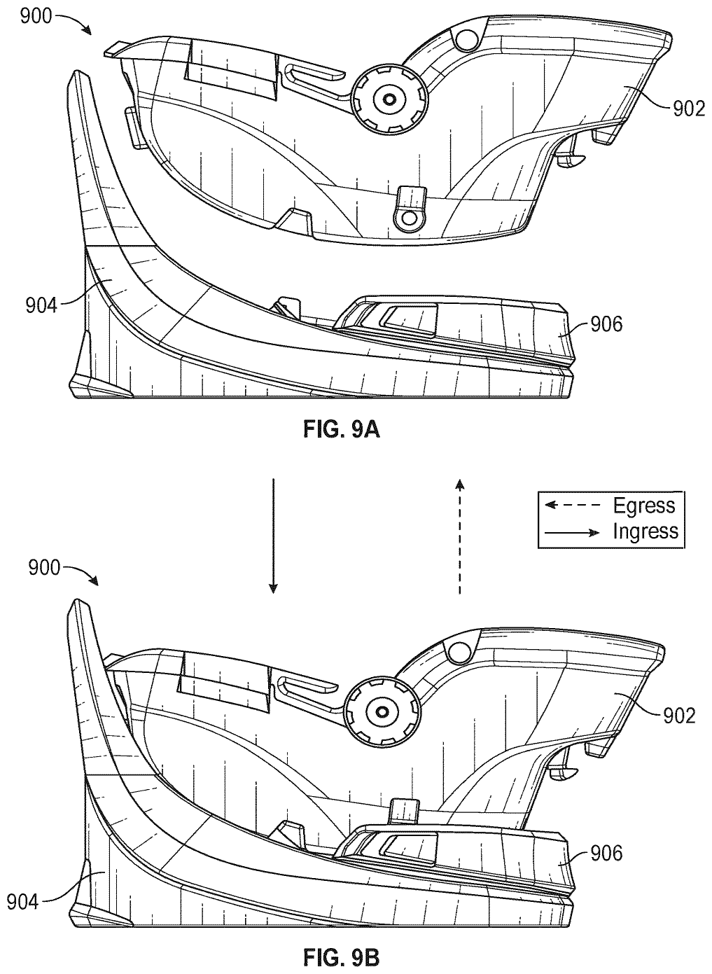

FIG. 9A-9B shows another exemplary process from removing a carrier 902 from the base (including a base body 904 and a turn table 906) of a car seat 900. FIG. 9A shows the carrier 902 separate from the base and FIG. 9B shows the carrier inserted onto the base (onto the turn table 906). Specifically, FIGS. 9A-9B show that the car seat 900 may still be used as a traditional car seat. As previously indicated, the actuator at the foot end of the carrier 902 may acuate the front hooks and push the rear hooks out of the way. That actuator may be accessible when the carrier 902 is in the locked, locked position. This allows a caretaker to lift the car seat 900 off the base without rotating the turn table 906. The caretaker may also drop the carrier 902 into position when the base is in the locked position. Chamfers on the bottom of the carrier hooks and rear hooks allow them to be pushed out of the way, and then sprung into a locked position when the carrier 902 is seated.

FIGS. 10A-10B shows a mechanism (including the second attachment point as described herein) for locking a carrier (not shown in the figure) to a turn table 1000. That is, the mechanism allows for the carrier to be locked into place on the turn table 1000 as the turn table 1000 is rotated on the base of the car seat but may also be actuated to allow the carrier to be removed from the turn table 1000 (and the car seat).

As previously indicated, the mechanism for locking the carrier to the turn table 1000 may include one or more retractable hooks (for example, first hook 1008, second hook 1010, or any other number of hooks) provided on the turn table 1000. The one or more retractable hooks are configured to interact with a rear bar 1002 (which may be the same as rear bar 314 or any other rear bar described herein) that is attached to the carrier (the rear bar 1002 is shown in FIGS. 10A-10B without the carrier to more clearly illustrate the locking mechanism, however, the rear bar 1002 is normally be attached to the carrier).

The rear hooks may be spring-loaded, such that the rear hooks naturally rest in the locked position shown in FIG. 10A. To allow the carrier to be locked on the turn table 1000, the rear hooks are configured to retract into cavities located behind the rear hooks by a force provided to the rear hooks. Accordingly, when the carrier is provided on the turn table 1000, the rear bar 1002 pushes the rear hooks into the cavities. When the carrier is in the final locked position, rear hooks automatically snap over the rear bar 1002 based on the force of the springs, thus locking the carrier on the turn table 1000 (as shown in FIG. 10A with the rear hooks situated over the rear bar 1000).

To unlock the carrier from the second attachment point, the actuator may be actuated, which causes a rotation of the rear bar 1002 toward the head-end of the carrier 300 (the mechanisms that cause this rotation were previously described). The head-end rotation of the rear bar 1002 also rotates the integrally attached hook pushers 1004 and 1006 (which may be the same as hook pushers 308 and 310 or any other hook pushers described herein or otherwise). The hook pusher 1004 and 1006 rotation pushes the rear hooks off the rear bar 1002 and the carrier 1000 is free to be removed from the base. FIG. 10B shows a close-up view of the rear hook 1112 retracted into the cavity 1112. Although not shown in the figure, the rear hook 1008 is similarly retracted into another corresponding cavity. With the rear hooks retracted and no longer snapped over the rear bar 1002, the rear bar 1002 and the carrier may be removed from the turn table 1000.

FIGS. 11A-11F show a close-up view of a mechanism (including the first attachment point as described herein) for locking the carrier in a locked position on the car seat. That is, the mechanism allows for the carrier to be locked into place on the base of the car seat such that the carrier remains fixed in one position until it is desired to rotate the carrier and/or remove the carrier from the base. Specifically, FIGS. 11A-11D illustrate the carrier being rotated into the locked position and FIGS. 11E-11F show the carrier being rotated out of the locked position into the unlocked position. The below description specifically pertains to embodiments in which the first attachment point includes multiple loops provided on the base that are configured to receive corresponding front hooks on the carrier. However, this description may vary depending on the type of mechanism used in the first attachment point to secure the carrier to the base body. That is, the specific mechanism shown in FIGS. 11A-11F is not intended to be limiting.

Beginning with FIGS. 11E-11F, the interactions that occur between the two front hooks (for example, first front hook 1102 and second front hook 1103) on the carrier and the loops on the base body as the carrier is rotated into the locked position are shown. The close-up views shown in FIGS. 11A-11C show that each of the loops may include outer ramped surfaces, interior surfaces, and a cavity. As an example, FIG. 11A shows the second loop 1102 as including first outer ramped surface 1112, second outer ramped surface 1113, first interior surface 1115, second interior surface 1117, and cavity 1119. Similar elements may be found on the second loop 1102 as well.

As the caretaker initiates rotation of the carrier from the unlocked position toward the locked position, the first hook 1108 eventually comes into contact with the second loop 1102 at the second outer ramped surface 1113. Given that the first hook 1108 also includes a ramped surface 1106, the ramped surface 1106 on the first hook 1108 slides along the second outer ramped surface 1113 and the first hook 1108 slides into the cavity 1119 in the second loop 1102.

This is shown in FIG. 11A.

Continuing with FIG. 11B, as the carrier continues to rotate, the first hook 1108 rotates through the cavity 1119 and comes into contact with the first interior surface 1115. The ramped surface 1106 of the first hook 1108 again interacts with the first interior surface 1115, allowing the first hook 1108 to slide across the first interior surface 1115 and out of the second loop 1102.

Continuing with FIG. 11C, the carrier continues to rotate and the first hook 1108 is rotated until first hook 1108 comes into contact with the second outer ramped surface 1123 on the first loop 1110. The same interaction that occurred between the first hook 1108 and the second outer ramped surface 1113 of the first loop 1110 then repeats and the first hook 1108 slides into the cavity 1129 in the first loop 1110 (shown in FIG. 11D).

Turning to FIGS. 11E-11F, the interactions that occur between the two front hooks (for example, first front hook 1102 and second front hook 1103) on the carrier and the loops on the base body as the carrier is rotated into the unlocked position are shown. As indicated previously, to initiate the process of unlocking the carrier from the first attachment point and rotating the carrier from the unlocked position, the caretaker actuates the carrier actuator 302. This causes the front hooks to release from the loops on the base body by rotating the front hooks at least partially out of the openings in the loops.

Following the rotation of the front hooks outwards from the openings in the loops, as the carrier (not shown in the figure) begins to rotate, the second front hook 1104 of the carrier starts interacting with the second loop 1102 on the base body (the loop in which the first front hook 1104 was secured when the carrier was in the locked position). In this example, the “second front hook” is the hook that is rotated out of the first attachment point first when the carrier is rotated from the locked position to the unlocked position). The first interaction is shown in FIG. 11E. The ramped surface 1106 on the second front hook 1104 slides past the internal ramped surface 1107 on the second loop 1102. The second front hook 1104 rotates out of the second loop 1102, allowing the carrier to continue to rotate. This style of interaction is repeated for the first front hook 1108 and the first loop 1110.

Once both front hooks clear the loops in which the front hooks were secured when the carrier was in the locked position (that is, the second front hook 1104 clears the second loop 1102 and the first front hook 1108 clears the first loop 1110), the carrier can continue to swing open until the first front hook 1108 contacts the second loop 1102. The ramped surface 1112 on the outside of the second loop 1102 slides against the ramped surface 1114 on the outside and underside of the first front hook 1108. The second front hook 1108 then falls into the opening in the second loop 1102.

The first interaction then repeats. The first front hook 1108 starts interacting with the second loop 1102. The interaction is shown in FIG. 11F. The ramped surface 1114 on the second front hook 1108 slides past the inside ramped surface 1116 on the second loop 1102. The second front hook 1108 rotates and clears the second loop 1102 allowing the carrier to continue to rotate. At this point both front hooks will have cleared both loops and the carrier can be free to fully turn towards the caretaker.

FIG. 11G shows a view of the car seat 1100 with the front hooks (for example, first front hook 1108 and second front hook 1104) of the carrier engaged with the loops (for example, first loop 1110 and second loop 1102) of the first attachment point of FIGS. 11A-11F (the carrier is not shown in the figure such that the front hooks and other components provided underneath the carrier and/or on top of the turn table are visible). That is, FIG. 11G shows the car seat 1100 in the locked position before the front actuator is actuated to allow the carrier and turn table to then be rotated.

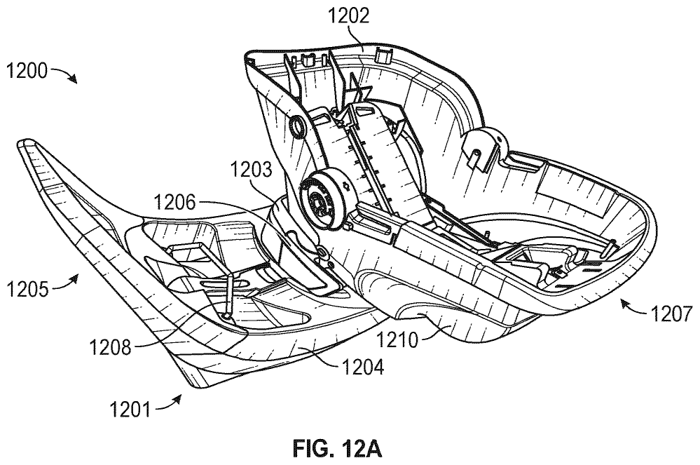

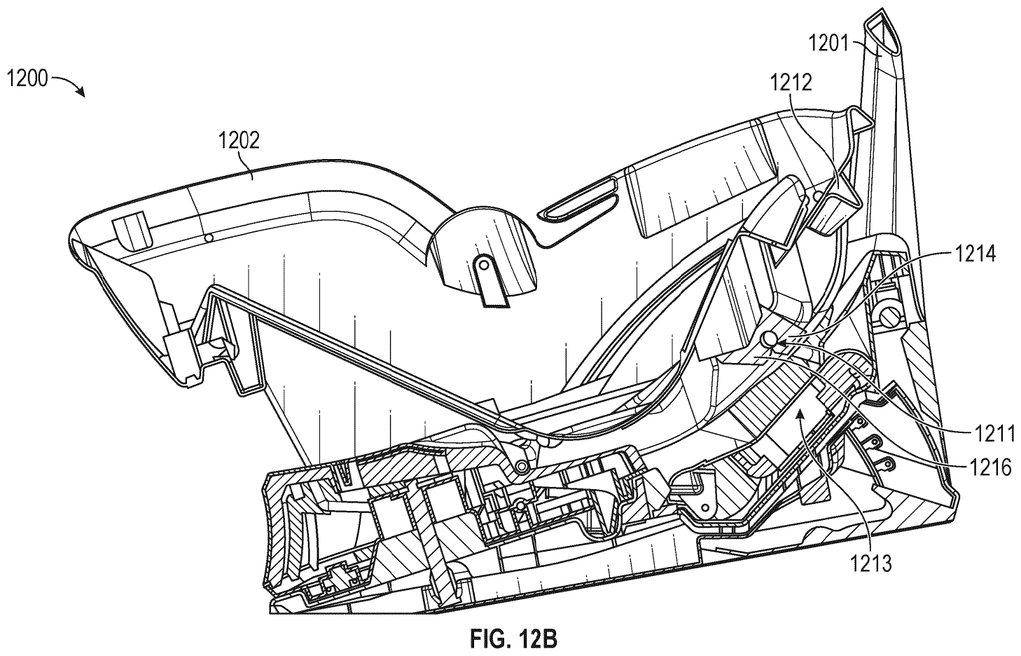

FIGS. 12A-12B show various views of another embodiment of a car seat 1200.

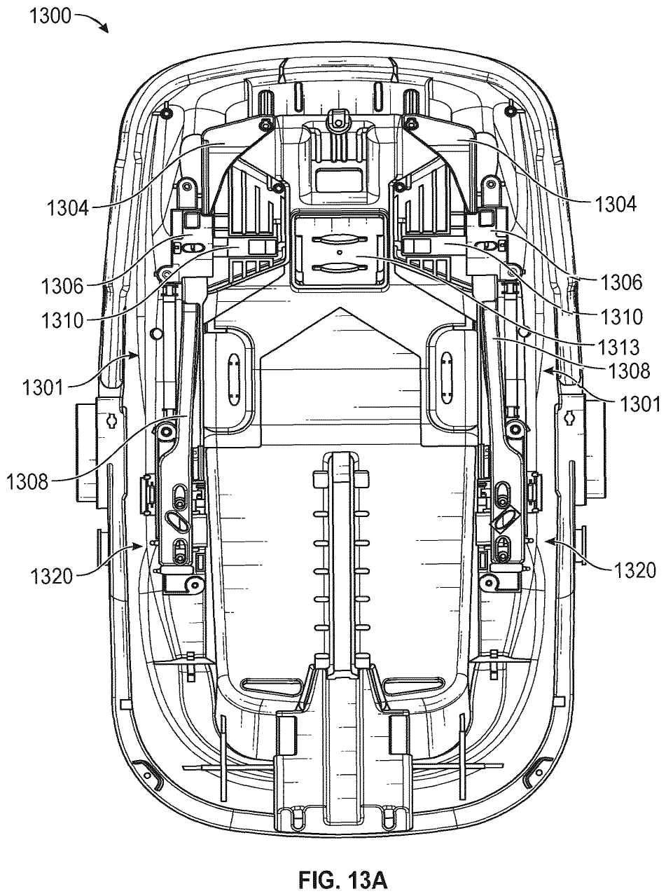

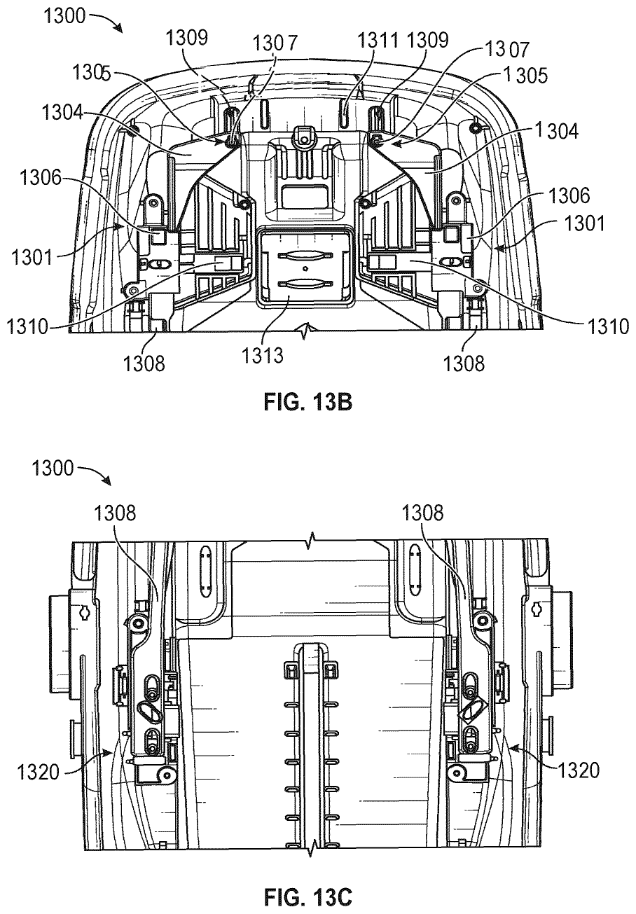

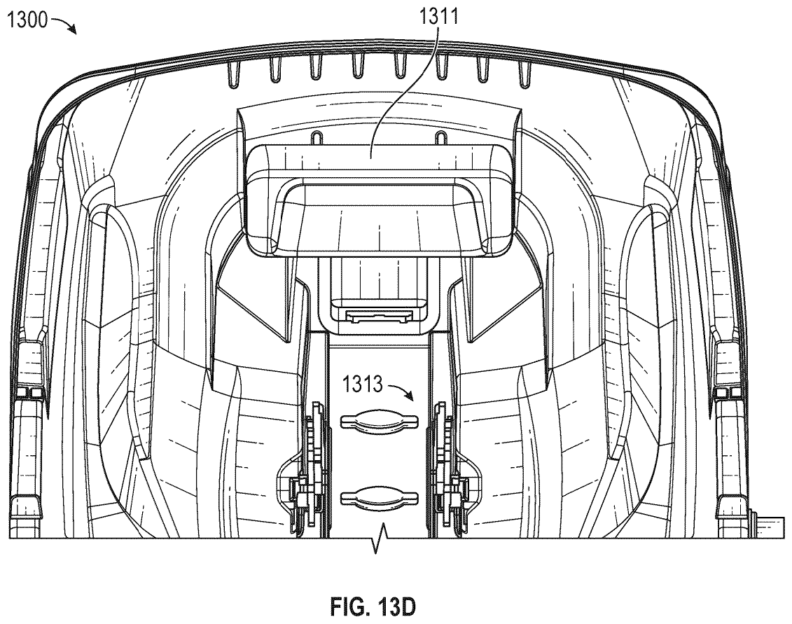

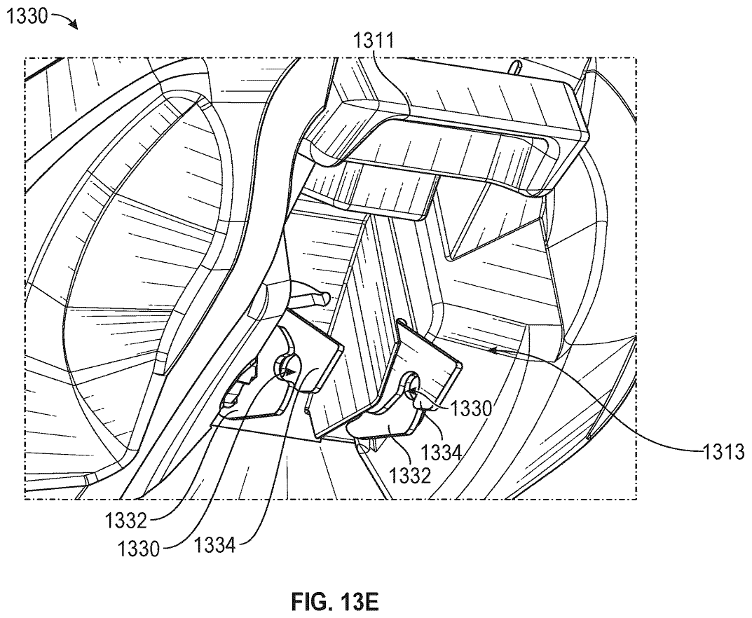

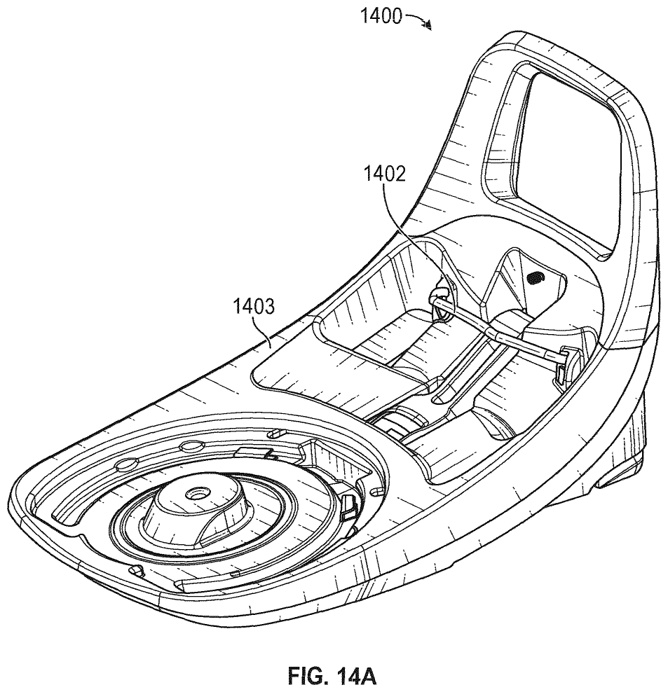

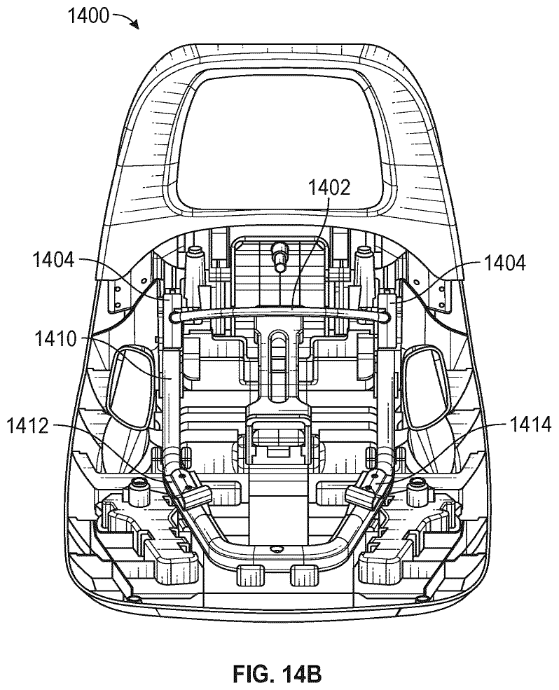

Specifically, FIG. 12A shows a perspective view of the car seat 1200 in a rotated position. FIG. 12B shows a perspective view of the car seat 1200 in a locked position. FIGS. 13A-15F show various sub-components of the car seat 1200.

Similar to the car seat(s) shown in the embodiments described with respect to FIGS. 1A-11G (for example, car seat 100, etc.), the car seat 1200 shown in the embodiment of FIG. 12A may include multiple attachment points that serve different purposes. For example, a first attachment point may be located at the base 1201 proximate to the foot end 1205 of the carrier 1202 and may selectively lock the carrier 1202 into the locked position (to prevent rotation of the carrier 1202 until it is desired for the carrier 1202 to be rotated). A second attachment point may also be located on the turn table that selectively locks the carrier 1202 onto the turn table 1203. This second attachment point allows the carrier 1202 to be rotated relative to the base 1201 via the turn table 1203 while keeping the carrier 1202 attached to the turn table 1203. The second attachment point also prevents the carrier 1202 from falling from the turn table 1203 when the front actuator 1212 is actuated to release the carrier 1202 from the first attachment point.

Accordingly, the car seat 1200 may share similar components with the car seat 100 (or any other car seat described with respect to FIGS. 1A-11G). For example, the car seat 1200 also includes the carrier 1202 (which may be the same as, or similar to, carrier 102, etc.) and the base 1201 (which may be the same as, or similar to, base 101, etc.) configured to receive the carrier 102 (via the turn table 1203, which may be the same as, or similar to, turn table 106, etc.). When it is desired that the car seat 1200 be used, the carrier 1202 is provided on the base 1201 (specifically, on the turn table 1203) within the vehicle. Likewise, when it is no longer desired for the car seat 1200 to be used (for example, if the caretaker wants to remove the infant from the vehicle in the carrier), the carrier 1202 may be removed from the base 1201. The base 1201 may also be removed from the vehicle and stored and/or the carrier 1202 may also remain on the base 1201 within the vehicle even when not in use.

The base 1201 includes a base body 1204 (which may be the same as, or similar to, base body 104) and the turn table 1203. The base body 1204 is the portion of the car seat 1200 that supports the other components of the car seat 1200 and may be provided on the seat of the vehicle (not shown in the figure). The base body 1204 may include at least some standard components of a car seat, such as vehicle belt attachment features, lock-off features, an optional ARB, leveling features, and/or level indication features. Some or all of these elements may also be provided on the turn table 1203 as well.

As indicated above, the turn table 1203 may be rotated up to 90 degrees to the left or up to 90 degrees to the right (or any other amount of rotation in either direction), however, any other amount of rotation may also be possible. Given that the turn table 1203 is configured to rotate both to the left and the right relative to the base body 1204, the foot end 1205 of the carrier 1202 may be rotated to face whichever vehicle door is closest to the car seat. FIG. 12B shows the carrier 1202 in a locked position in which the foot end 1207 of the carrier 1202 is facing the seat of the vehicle. FIG. 12A shows the carrier 1202 in a rotated position in which the foot end 1205 of the carrier 1202 is facing a door of the vehicle (the vehicle is not shown in the figure).

However, in contrast with the car seat 100 (or any other car seat described with respect to FIGS. 1A-11G), the car seat 1200 includes at least some different types of mechanisms to engage and disengage the first and second attachment points (however, some of the mechanisms may be the same in the car seat 100 and the car seat 1200). One portion of the first attachment point is visible in the perspective shown in FIG. 12A (specifically, the portion of the attachment point that is provided on the base 1201 that engages with mechanisms provided on the carrier 1202). Particularly, in contrast with the embodiments shown in FIGS. 1A-11G in which the first attachment point includes one or more loops (such as the first loop 206 and the second loop 208, for example) provided on the base, the embodiment shown in FIG. 12A includes an attachment bar 1208 provided on the base 1201.

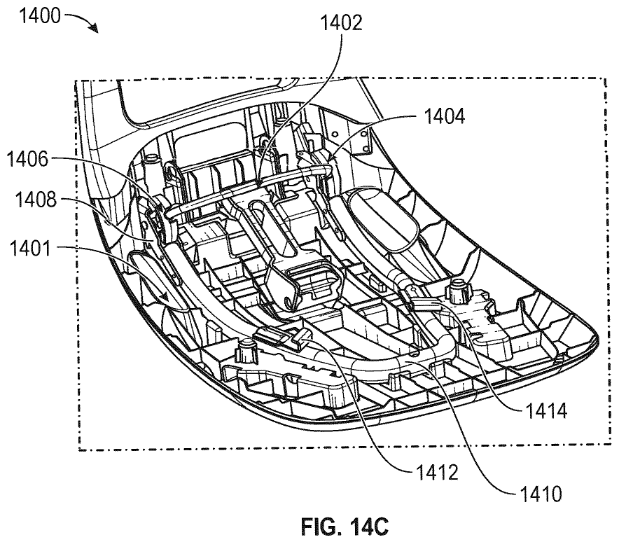

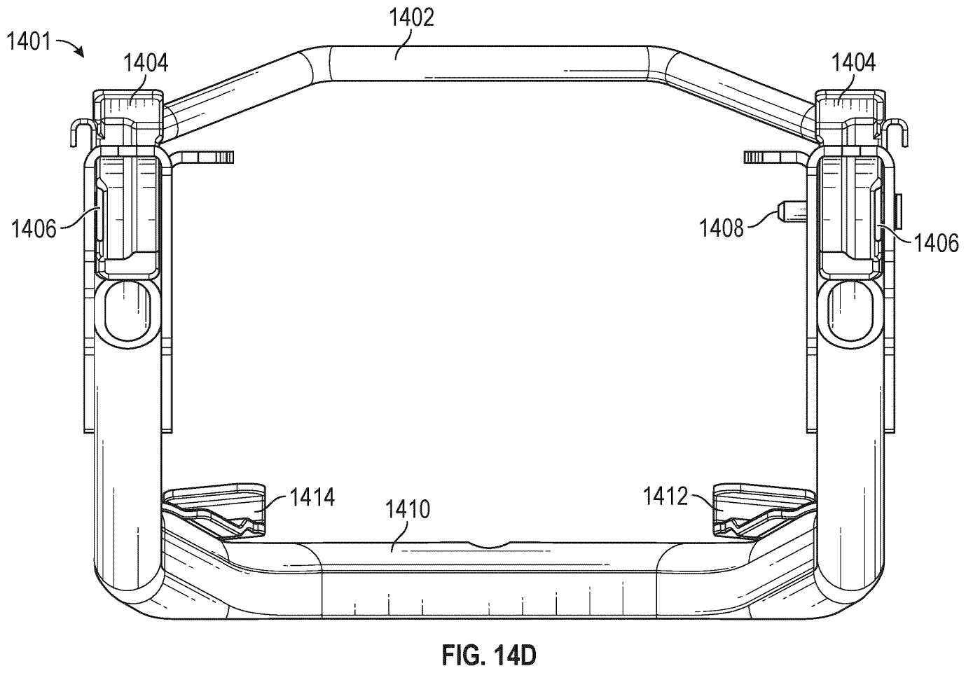

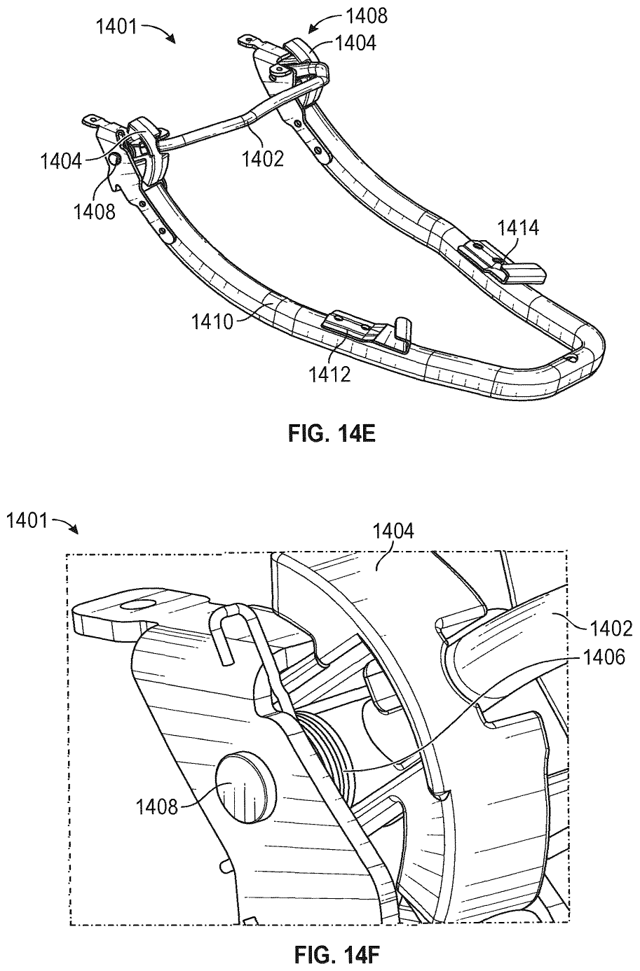

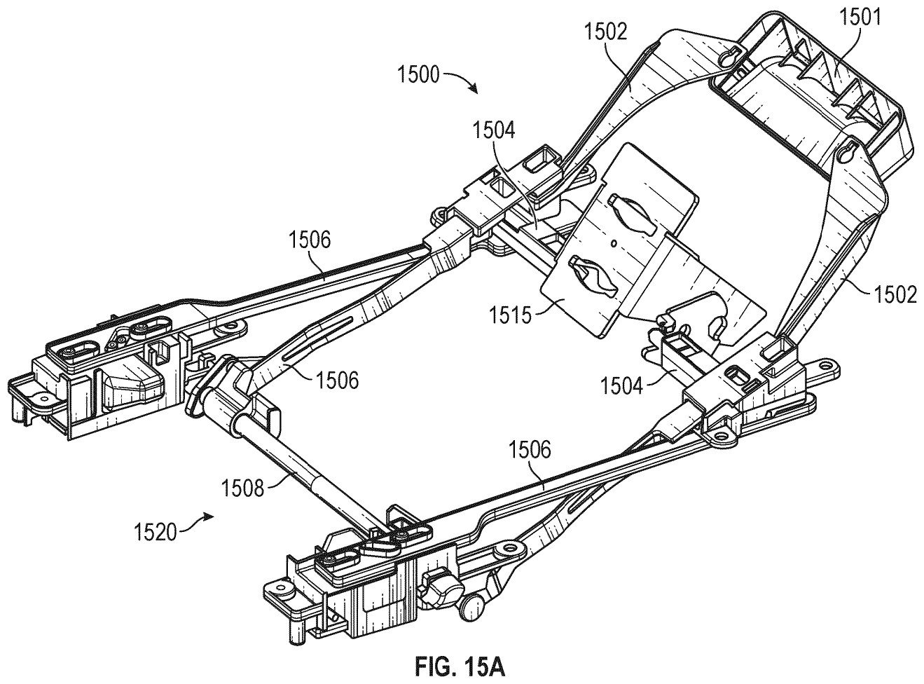

In this alternative embodiment, when the carrier 1202 is in the rotated position, the attachment bar 1208 remains in an upright position (the default position of the attachment bar 1208) as shown in FIG. 12A. However, when the carrier 1202 is rotated towards the foot end 1205 of the car seat 1200, a ramp 1210 located on a bottom portion of the carrier 1202 begins to interact with the attachment bar 1208 by sliding along the attachment bar 1208. As the ramp 1210 continues to slide across the attachment bar 1208, the attachment bar 1208 is forced down into a second position by the ramp 1210. Although the perspective of FIG. 12A only shows one ramp 1210 on one side of the carrier 1202, another ramp may also be provided on the opposite side of the carrier 1202 such that the carrier may be rotated in either direction. For example, if the car seat 1200 is provided on one side of the car, the user may want to rotate the carrier 1202 in a first direction towards one door of the car, however, if the car seat 1200 is provided on another side of the car, the user may want to rotate the carrier 1202 in the opposite direction towards another door. FIGS. 14A-14F provide further details about the structure of the mechanism that allows for the rotation of the attachment bar 1208.

When the carrier 1202 is fully rotated into the locked position (shown in FIG. 12B, for example), the attachment bar 1208 may be received within a void 1211 formed within front hooks 1213. In one or more embodiments, the front hooks 1213 may include top hooks 1214 and bottom hooks 1216. Although only one of each of the top hooks 1214 and one of the bottom hooks 1216 are shown in the view in FIG. 12B, the front hooks 1213 may actually include two top hooks and two bottom hooks (this is shown in FIGS. 13D and 13E, for example), or any other number of top hooks and bottom hooks. The specific configuration of the front hooks 1213 including top hooks and bottom hooks is merely exemplary and the front hooks 1213 may also be configured in any other suitable manner to hold the attachment bar 1208 in a locked position. Additionally, any other type of structure other than the front hooks 1213 may be used to lock the attachment bar 1208 in place when the car seat 1200 is in the locked position.

Once the carrier 1202 is fully rotated and in the locked position, the attachment bar 1208 is locked into place within the front hooks 1213 until another mechanism of the car seat 1200 is actuated via an actuator to release the attachment bar 1208 from the front hooks 1213. In one or more embodiments, there may be two mechanisms that allow for the attachment bar 1208 to be released from within the front hooks 1213. The first mechanism may be a front locking mechanism (such as front locking mechanisms 1301 and 1500, which are described in further detail below) that may be actuated via a front actuator 1212 that is located at the foot end of the carrier 1202. For example, when the front actuator 1212 is actuated, the front locking mechanism causes the front hooks 1213 to open such that the attachment bar 1208 is then able to freely be removed from the front hooks 1213. For example, the front hooks 1213 may open through a rotation of the bottom hooks 1216 relative to the top hooks 1214 (however, the top hooks 1214 and/or bottom hooks 1216 may also rotate relative to one another in any other suitable manner).

The front actuator 1212 may be configured to actuate in any number of different ways. For example, a user may manually pull the front actuator 1212 upwards to actuate the front hooks 1213. However, the front actuator 1212 may be configured to be actuated in any other manner. Further details about the mechanisms that allow for this actuation are provided with respect to at least FIGS. 13A-13E.

The second mechanism may be a rear locking mechanism (for example, rear locking mechanisms 1320 and 1520, which are described in further detail below) that may be actuated via a rear actuator 1206 (shown in FIG. 12A). In one or more embodiments, the rear actuator 1206 may be provided on the turn table 1203. The rear actuator 1206 may be actuated, for example, by a user pulling outwards on a handle of the rear actuator 1206. However, the rear actuator 1206 may also be configured to actuate in any other suitable manner. Although the perspective of FIG. 12A only shows one rear actuator on one side of the turn table 1203, there may also be a second rear actuator positioned on the other side of the turn table as well 1203 (accordingly, any reference to a “rear actuator” is not intended to be limiting and may also refer to any other number of rear actuators). The front and rear locking mechanism may also be referred to interchangeably herein as front and rear locking mechanisms (for example, there may be two of such mechanisms on either side of the carrier). Any reference to a “mechanism” or “mechanisms” is not intended to limit the scope of the number of components that may be included.

While the rear actuator 1206 may only cause the disengagement of the first attachment point such that the carrier 1202 may be freely rotated about the base 1201 on the turn table 1203, the front actuator 1212 may cause the disengagement of both the first attachment point and the second attachment point such that the carrier 1202 may then be completely removed from the turn table 1203 and the car seat 1200.

The front actuator 1212 may be configured to cause the disengagement of both the first and second attachment points via a combination of the front locking mechanism to disengage the first attachment point and an additional mechanism (previously described with respect to FIGS. 1A-11G, more specifically at least FIGS. 10A-10B) to disengage the second attachment point. These two mechanisms may be mechanically connected and may work in conjunction to simultaneously cause the disengagement of the first and second attachment points. For example, the front actuator 1212 may be the same as, or similar to, the second actuator described above with respect to FIGS. 1A-11G (likewise, the rear actuator may be the same as, or similar to, the first actuator described above). That is, a user may actuate the front actuator 1212, which causes the rear bar to rotate (based on a movement of the front locking mechanisms 1301) and push the rear hooks into cavities located behind the rear hooks. This frees the rear bar from the rear hooks, allowing the carrier to then be removed from the turn table. The rear hooks may be spring-loaded such that they naturally return to their original position once the second actuator is released. The front actuator 1212 may also cause any other change that allows the carrier to be rotated relative to the base depending on the type of mechanism that is used with the second attachment point. These elements (the rear bar, rear hooks, etc.) are described above in detail with respect to FIGS. 1A-11G (more specifically at least FIGS. 10A-10B).

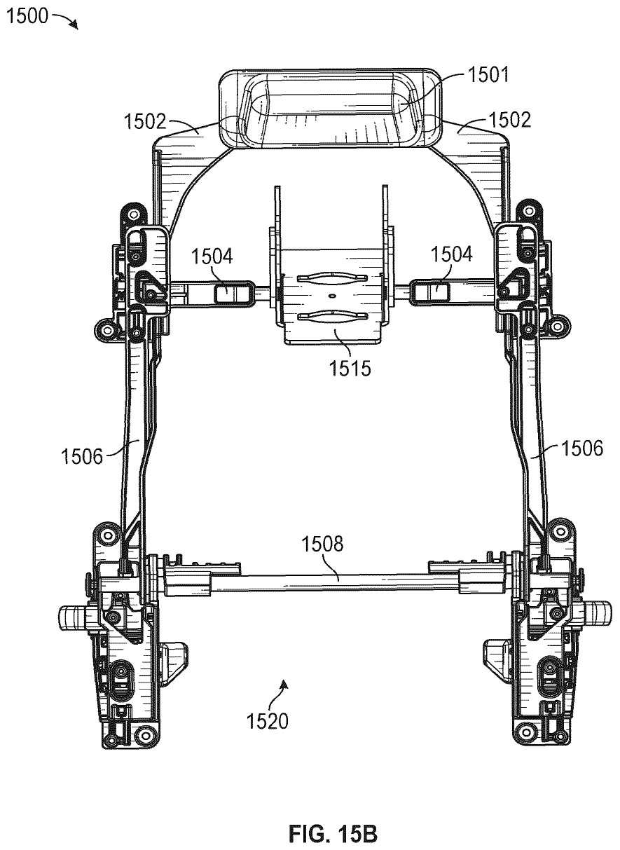

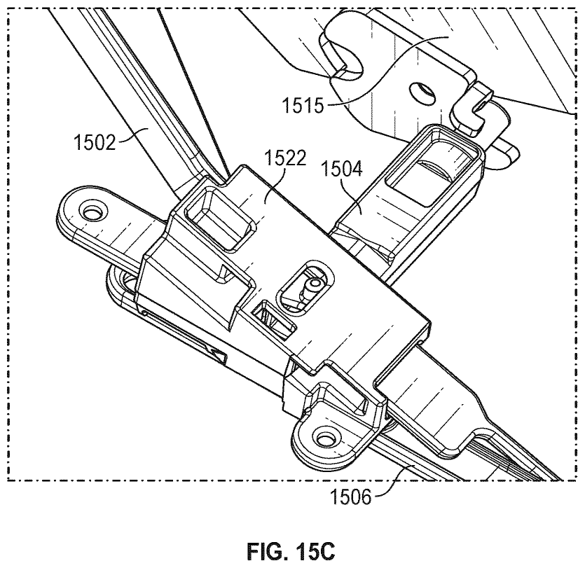

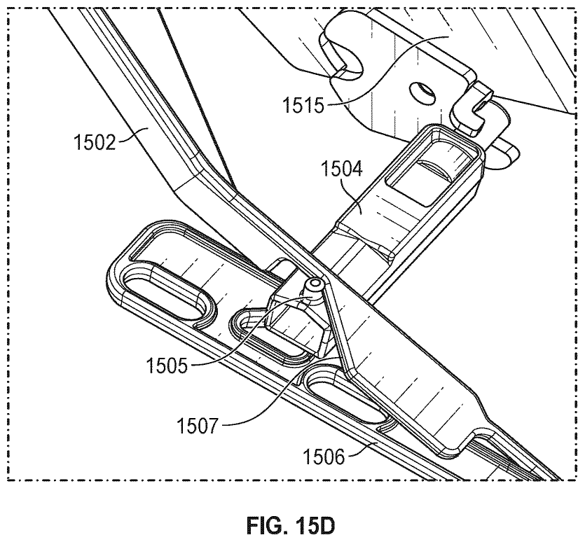

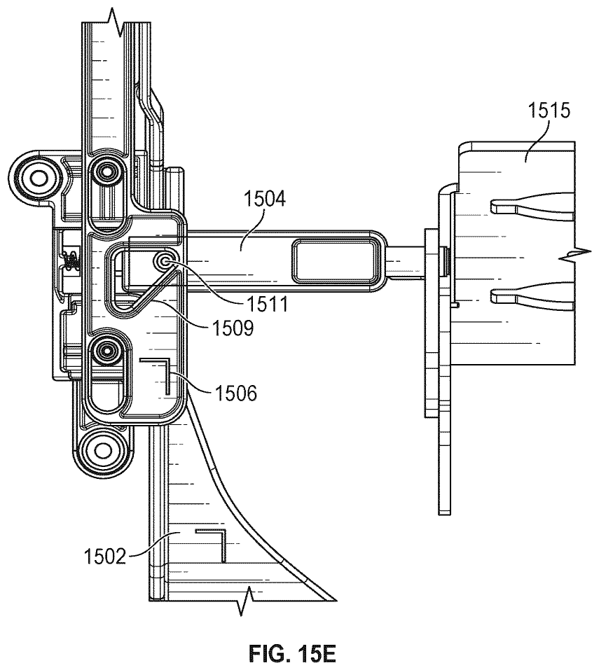

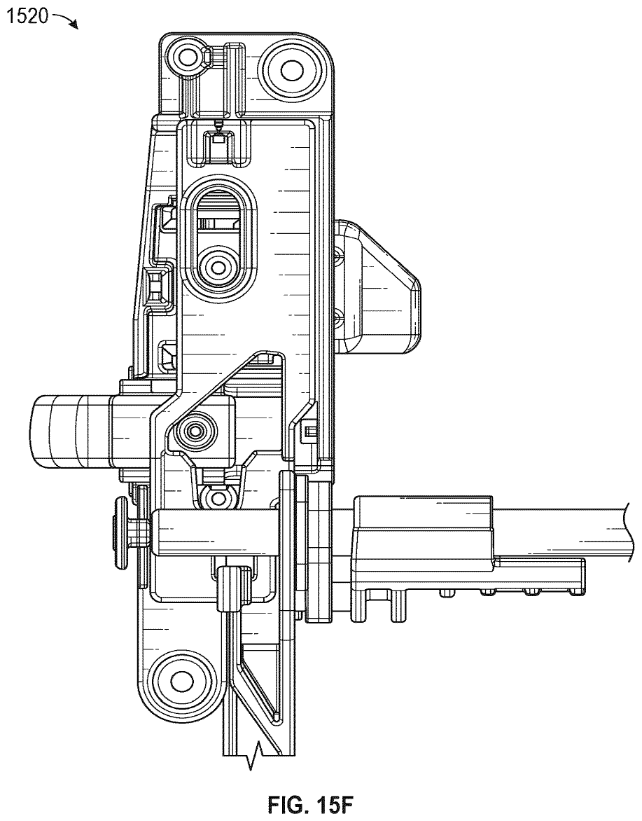

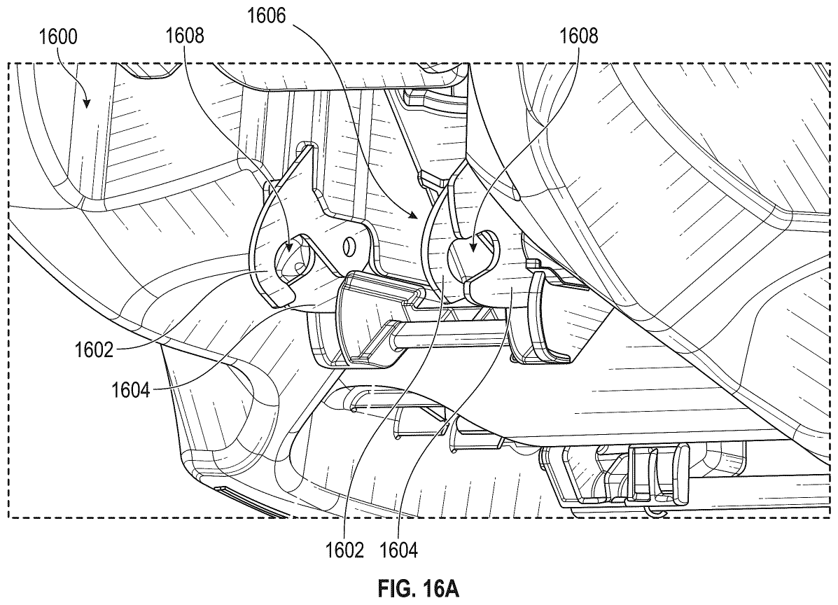

The internal mechanisms of the carrier 1202 that allow for the engagement and disengagement of the first and second attachment points are illustrated in at least FIGS. 13A-13E and 15A-15F and the internal mechanism of the base 1201 that allows for the engagement and disengagement of the attachment bar 1208 in particular is illustrated in at least FIGS. 14A-14E.

FIGS. 13A-13E show different views of a carrier 1300 (which may be the same as, or similar to, carrier 1202 of FIGS. 12A-12B) of a car seat (not shown in the figure but may be the same as, or similar to, car seat 1200). Specifically, FIGS. 13A-13E show in more detail at least portions of the mechanisms that cause the engagement and disengagement of the first and second attachment points to allow the carrier 1300 to be rotated relative to the base (not shown in the figure) and to be removed completely from the base.

Beginning with FIG. 13A, a top-down view of the carrier 1300 is shown. The mechanisms shown in the perspective of FIG. 13A may be configured to engage and disengage either or both the first attachment point and the second attachment point based on the specific actuator of the car seat that is actuated. In one or more embodiments, mechanisms may include front locking mechanisms 1301 and rear locking mechanisms 1320. The front locking mechanisms 1301 may include at least front pull links 1304, front mechanism housings 1306, rear pull links 1308, lock pins 1310, and rear mechanism housings 1312. It should be noted that the specific configuration of the front locking mechanisms 1301 as shown in the figures is merely exemplary and other arrangements of these components or substitution of other components may also be possible. Further, additional or fewer components may also be included in the front locking mechanisms 1301.

FIG. 13B shows a top-down close-up view of the front locking mechanisms 1301 of the carrier 1300. The front locking mechanisms 1301 are configured to engage and disengage the first attachment point (for example, engage and disengage the attachment bar 1208 and the front hooks 1313 (shown as front hooks 1213 in FIG. 12B) or any other structure used to lock the attachment bar 1208 in place when the carrier 1300 is in the locked position. As indicated above, the front locking mechanisms 1301 include the front pull links 1304, front mechanism housings 1306, rear pull links 1308, and lock pins 1310. The front locking mechanisms 1301 may be controlled by actuation of the front actuator (for example, front actuator 1212 or any other front actuator).

The front pull links 1304 may be connected to the front actuator 1311 (which may be the same as front actuator 1212) through the carrier 1300. The front pull links 1304 may be connected to the front actuator 1311 in any number of different ways. In one exemplary embodiment shown in FIG. 13B, the front pull links 1304 include holes 1305 that are configured to receive protruding elements 1307 located on the rear of the front actuator 1311 (the side of the front actuator 1311 that faces the carrier 1300). The carrier 1300 may also include notches 1309 that are also configured to receive the protruding elements 1307. The notches 1309 of the carrier 1300 align with the holes 1305 of the front pull links 1304 such that the protruding elements 1307 extend through both the notches 1309 of the carrier 1300 and the holes 1305 of the front pull links 1304. The protruding elements 1307 may be sized and shaped such that the protruding elements 1307 remain fixed within the holes 1305 of the front pull links 1304 unless a sufficient force is provided to remove the protruding elements 1307 from the holes 1305. The protruding elements 1307 may also be secured within the holes 1305 in any other suitable manner.

As shown in FIG. 13B, the notches 1309 may be elongated such that the protruding elements 1307 can translate vertically through the notches 1309 based on the actuation of the front actuator 1311. For example, if a user pulls upward on the front actuator 1311, the front 1311 is translated vertically in the upward direction, thereby causing the protruding elements 1307 to translate upward through the notches 1309 in the same direction. Given that the protruding elements 1307 are provided within the holes 1305 of the front pull links 1304, the translation of the front actuator 1301 and the protruding elements 1307 causes a similar translation of the front pull links 1304 in the upward direction as well.

The vertical translation of the front pull links 1304 also causes the lock pins 1310 to translate in a horizontal direction (specifically, outwards away from the locks (this translation direction is shown by the arrows in FIG. 13B). This, in turn, causes the front hooks 1313 to actuate in a manner described with respect to FIG. 12B such that the attachment bar (not shown in FIG. 13B, but shown as attachment bar 1208 in FIG. 12A) may then be freely removed from the front hooks 1313. That is, the actuation of the front actuator 1301 allows the carrier 1300 to then be freely rotated relative to the base (not shown in the figure) using the turn table (not shown in the figure) given that the carrier 1300 and base are no longer engaged at the first attachment point (the engagement of the attachment bar 1208 shown in FIG. 12A and the front hooks 1213, 1313, etc.).

As is described further with respect to at least FIG. 15D, the lock pins 1310 may be spring-loaded and naturally biased towards front hooks 1313 (such that the locking pins 1310 tend to naturally remain more proximate to the front hooks 1313 such that the front hooks 1313 is in a locked position). Thus, when the user releases the front actuator 1311, the locking pins 1310 are forced back inwards towards the front hooks 1313 by the springs (not shown in the figure). This translation of the locking pins 1310 produces a downward force on the front pull links 1304. This, in turn, causes the front actuator 1311 to return to its default position until the user pulls the front actuator 1311 upwards again to actuate the front actuator 1311.

The mechanisms that cause the lock pins 1310 to translate horizontally (and the front actuator 1301 and the front pull links 1304 to naturally translate downwards when not actuated by the user) are provided within the front mechanism housings 1306 and may not be visible in the perspective shown in FIG. 13B, however, the mechanisms and their operation are described further with respect to FIG. 15D. FIG. 13C shows a top-down close-up view of the rear locking mechanisms 1320 of the carrier 1300. In one or more embodiments, the rear locking mechanisms 1320 may operate in the same, or a similar manner, to engage and disengage the first attachment point of the car seat as the mechanism shown in FIG. 3B (the mechanism used for the car seat described with respect to FIGS. 1A-11G). For example, the rear pull links 1308 may be the same as rear pull links 333, etc. The rear pull links 1308 may extend up towards the lock pins 1310. For example, the rear pull links 1308 may form a mechanical connection with an underside of the lock pins 1310 in a similar manner that the front pull links 1304 have a mechanical connection with the top side of the locking pins 1310, as shown in FIG. 13B. Similar to the front pull links 1304, the rear pull links 1308 may also include ramped surfaces that interact with the locking pins 1310 to cause a translation of the locking pins 1310 in a similar manner that the front pull links 1304 may cause a translation of the locking pins 1310. This interaction is shown and described in further detail with respect to FIG. 15E. The front locking mechanisms 1301 may be controlled by actuation of the rear actuator (for example, rear actuator 1206 or any other rear actuator).

FIG. 13D shows a close-up view of the rear of the carrier 1300. FIG. 13E shows a close-up perspective view of the rear of the carrier 1300. The views of FIGS. 13D-13E more clearly show the front actuator 1311 and the front hooks 1313. FIG. 3E also specifically shows the top hooks 1334 (which may be the same as, or similar to, the top hooks 1214), the bottom hooks 1332 (which may be the same as, or similar to, the bottom hooks 1216), and the voids 1330 (which may be the same as, or similar to, the voids 1211).

FIGS. 14A-14C show various views of a base 1400 (which may be the same as, or similar to, the base 1201, for example) without a carrier and a turn table provided on the base 1400. Specifically, FIG. 14A shows a perspective view of the base 1400 and the attachment bar 1402 (which may be the same as, or similar to, attachment bar 1208).

FIG. 14B shows a top-down view of the base 1400 with a top cover 1403 of the base 1400 removed such that at least some of the internal mechanisms of the base 1400 are visible. FIG. 14C shows a perspective view of the base 1400 with the top cover 1403 of the base 1400 removed. In particular, FIGS. 14B and 14C show the rotational mechanism 1401 that is included in the base 1400 to allow for the rotation of the attachment bar 1402 (for example, the ability of the attachment bar 1402 to be pushed downward by the ramp(s) on the bottom of the carrier, as described with respect to FIG. 12A). These rotational mechanism 1401 is shown as removed from the base 1400 in FIGS. 14D and 14E. FIG. 14D shows a rear view of the rotational mechanism 1401 for the attachment bar 1402. FIG. 14E shows a perspective view of the rotational mechanism 1401 of FIG. 14D.

In one or more embodiments, the rotational mechanism 1401 of the base 1400 shown in FIGS. 14B and 14C may include, for example, front attachment bar spring housings 1404, front attachment bar springs 1406, and front attachment bar pins 1408. The rotational mechanism 1401 may also include a support structure 1410 to secure the rotational mechanism 1401 within the base 1400. Although one particular configuration of a support structure 1410 is shown in the figures, the support structure 1410 may also be any other configuration (including any other shape, size, etc.) depending on the specific configuration of the base 1400. In one or more embodiments, one or more tabs (for example, first tab 1412 and second tab 1414 (or any other number of tabs) may be affixed to the support structure 1410. The one or more tabs may be configured to engage with an underside of the top cover 1403 of the base 1400.

In one or more embodiments, to allow for the rotation of the attachment bar 1402 relative to the rest of the rotational mechanism 1401, the attachment bar 1402 may be attached to the font attachment bar spring housings 1404. Springs 1406 may be connected to the font attachment bar spring housings 1404. The springs may naturally bias the attachment bar 1402 towards the upright position (shown in FIG. 12A, for example). However, when a force is applied to the attachment bar 1402 (for example, by a ramp on the carrier, as described with respect to FIG. 12A), the rotation of the attachment bar 1402 causes the rotation of the font attachment bar spring housings 1404 relative to the support structure 1410. When the force is removed from the attachment bar 1402, the force of the springs causes the attachment bar 1402 to rotate back to its natural upright position. That is, in one or more embodiments, the attachment bar 1402 and the font attachment bar spring housings 1404 may be configured to rotate and the remainder of the rotational mechanism 1401 may remain fixed.

FIGS. 15A-15F show various views of the mechanisms (for example, the front locking mechanisms 1500 and the rear locking mechanisms 1520, which may be the same as, or similar to, front locking mechanisms 1301 and front locking mechanisms 1320) used to engage and disengage the first and second attachment points (without the other elements of the car seat, such as the carrier, base, etc.). In one or more embodiments, both the front locking mechanism 1500 and the rear locking mechanism 1520 may be used to disengage the first attachment point to unlock the carrier from the locked position on the base to allow the carrier to be freely rotated about the base on the turn table. That is, the carrier may be disengaged from the first attachment point either by actuation of the front actuator or the rear actuator. The front locking mechanism 1500 may also be configured to (by operating in conjunction with additional mechanisms) disengage the second attachment point such that the carrier may then be removed from the car seat.

Beginning with FIG. 15A, a perspective view of the locking mechanisms (including front locking mechanisms 1500 and rear locking mechanisms 1520, for example) is shown. FIG. 15B shows a top-down view of the locking mechanisms. Similar to front locking mechanisms (for example, front locking mechanisms 1301 or any other front locking mechanisms) described in previous figures, the front locking mechanisms 1500 may include the front actuator 1501, the front pull links 1502, front mechanism housings 1503 (shown in FIG. 15C), rear pull links 1506, and lock pins 1504. The rear locking mechanisms 1520 may include similar structure as locking mechanisms described with respect to the embodiments of FIGS. 1A-11G (for example, as indicated above with respect to FIG. 13C, the rear locking mechanisms 1520 may include rear pull links 1506, which may be the same as, or similar to, rear pull links 333).

FIG. 15A also shows additional mechanisms that form a mechanical connection with the front locking mechanisms 1500 and operation in conjunction with the front locking mechanisms 1500 to cause the disengagement of the second attachment point. For example, the additional mechanisms may include at least the rear bar 1508 (which may be the same as the rear bar 314, rear bar 1002, etc.) and/or any other mechanisms described above with respect to FIGS. 1A-11G (more specifically, at least FIGS. 10A-10B) that cause the disengagement of the second attachment point.

FIG. 15C shows a close-up view of a portion of the front locking mechanisms 1500 with a housing 1522. FIG. 15D shows a close-up view of the front locking mechanisms 1500 without the housing 1522. FIG. 15E shows a bottom-up close-up view of the front locking mechanisms 1500 with the housing 1522.

The close-up view shows one of the locking pins 1504 and the mechanism that causes the locking pin 1504 to translate horizontally inwards towards the front hooks 1515 and outwards away from the front hooks 1506. In one or more embodiments, the locking pins 1504 includes protruding elements 1505 that are configured to slidably engage with ramps 1507 of the front pull links 1502. That is, when the front actuator 1501 is actuated (e.g., pulled upwards) by a user, the front pull links 1502 also translate upwards. As the front pulls links 1502 translate upwards, the protruding elements 1505 of the locking pins 1504 slide down the ramps 1507 of the front pull links 1502. The ramps 1507 are specifically angled outwards and away from the front hooks 1515 such that the protruding elements 1505 are also forced outwards as the protruding elements 1505 slide along the ramps 1507. Consequentially, this sliding motion pulls the locking pins 1504 in the outward direction away from the front hooks 1515.

Likewise, when the front actuator 1501 is released, the front pull links 1502 return to their default position (that is, the front pull links 1502 translate back downwards). As the front pulls links 1502 translate back downwards, the protruding elements 1505 of the locking pins 1504 slide up the ramps 1507 of the front pull links 1502. In one or more embodiments, the locking pins 1504 may be spring-loaded such that the locking pins 1504 are naturally biased towards the hooks 1515. Thus, when the locking pins 1504 are not forced outwards away from the hooks 1515 when the ramps 1507 slide against the protruding elements 1505, the locking pins 1504 are forced back towards the front hooks 1515 by the springs (not shown in the figure).

FIG. 15F shows a bottom-up view of the rear locking mechanisms 1520. As indicated above, the rear locking mechanisms 1520 may include similar structure as similar locking mechanisms described above with respect to FIGS. 1A-11G. For example, as indicated above with respect to FIG. 13C, the rear locking mechanisms 1520 may include rear pull links 1506, which may be the same as, or similar to, rear pull links 333.

As indicated above, the actuation of the rear locking mechanisms 1520 using the rear actuator(s) (for example, rear actuator 1206 shown in FIG. 12A) provides another way to cause the disengagement of the first attachment point such that the carrier may then be rotated using the turn table (as mentioned above, the first attachment point may also be disengaged via an actuation of the front actuator). To allow the actuation of the rear actuator to also disengage the first attachment point, the rear pull links 1506 may also include ramped surfaces (for example, ramps 1509 shown in FIG. 15E that interact with additional protruding elements 1511 on the underside of the locking pins 1504. Accordingly, when the rear pull links 1506 translate away from the front locking mechanisms 1500 based on the actuation of the rear actuator(s), the additional protruding elements 1511 of the locking pins 1504 slide down the ramps 1509 of the rear pull links 1506. As described above with respect to the operation of the front locking mechanisms 1500, the locking pins 1504 may be spring-loaded such that the locking pins 1504 are naturally biased towards the front hooks 1515. Thus, when the locking pins 1504 are not forced outwards away from the front hooks 1515 (by the actuation of the rear actuator(s)) when the ramps 1509 slide against the additional protruding elements 1511, the locking pins 1504 are forced back towards the front hooks 1515 by the springs (not shown in the figure). That is, the rear pull links 1506 disengage and engage the first attachment point by causing a translation of the locking pins 1504 in a similar manner that the ramps 1509 of the front pull links 1502 cause a similar translation of the locking pins 1504.

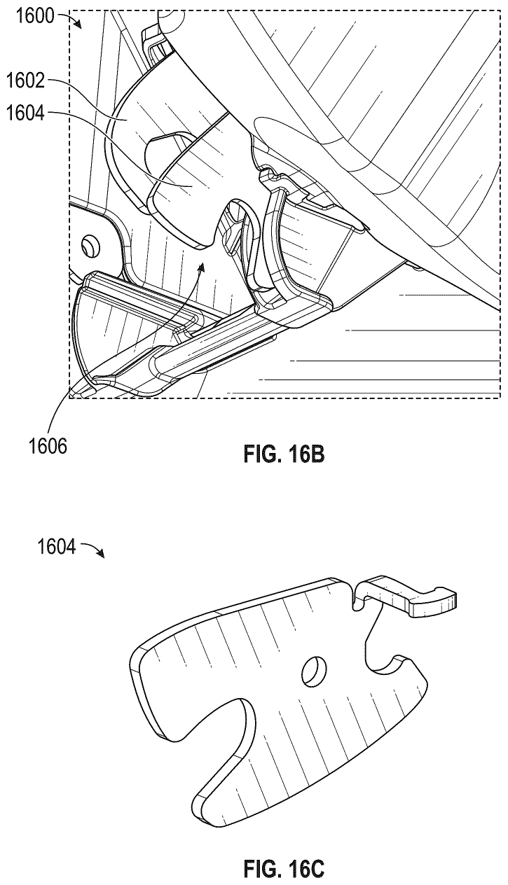

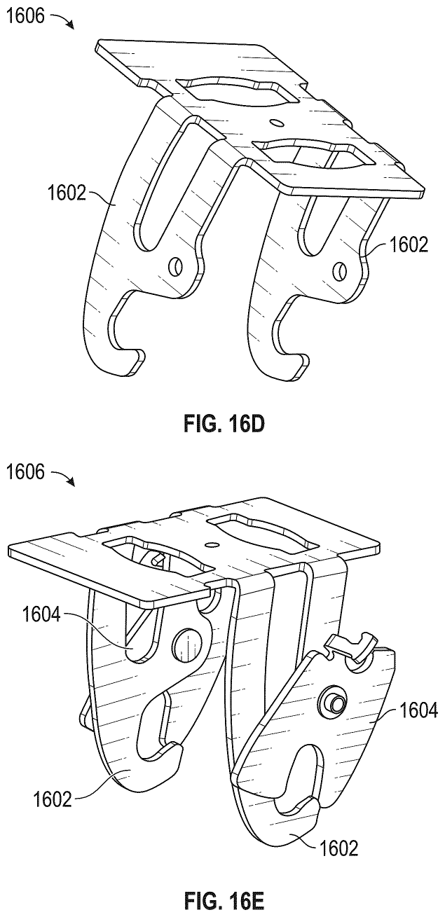

FIGS. 16A-16E show a variation of front hooks that may be included on a carrier 1600 (which may be the same as, or similar to, carrier 102, carrier 300, and/or any other carrier described herein). For example, the front hooks shown in FIGS. 16A-16E may be a variation of the structure that includes the front hooks 1313 shown in FIG. 13E. In this variation, the front hooks include hooks 1602 and locking pieces 1604 that form a standalone assembly 1606. For example, the locking pieces 1604 may be riveted or otherwise removably or permanently attached to the hooks 1602. This standalone assembly 1606 may then be riveted or otherwise removably or permanently attached to the carrier 1600. Creating the front hooks 1602 as this standalone subassembly 1606 provides for easier manufacturing, a reduction in the risk of incorrect assembly, and lower weight. FIGS. 16A-16B show the standalone assembly 1606 attached to the carrier 1600 (with FIG. 16B showing a close-up view of one hook 1602 and locking piece 1604 of the standalone assembly 1606). FIG. 16C shows one locking piece 1604 on its own, FIG. 16D shows hooks 1602 attached to the standalone assembly 1606 without the locking pieces 1604, and FIG. 16E shows the entire standalone assembly 1606 that includes the hooks 1602 and the locking pieces 1604.

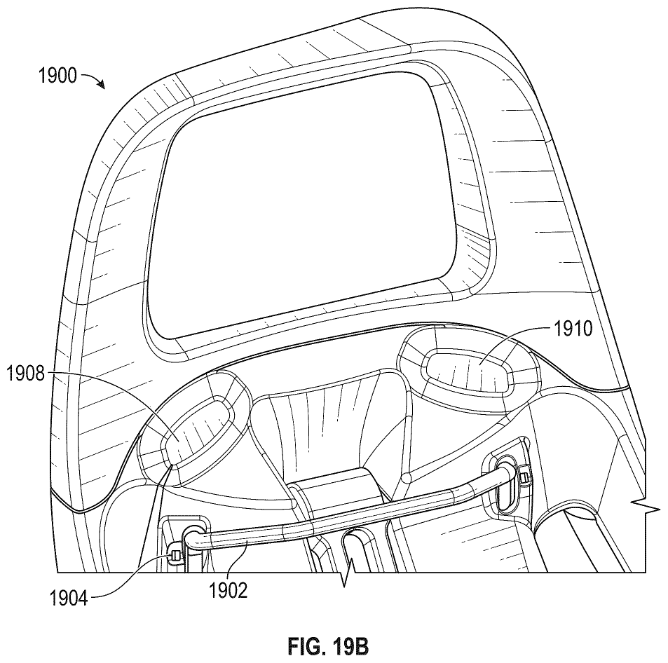

In addition to the hooks 1602 and locking pieces 1604 being combined in a standalone assembly 1606, the variation shown in FIGS. 16A-16C also includes an adjustment to the geometry of the hooks 1602 and locking pieces 1604. The geometry change helps the hooks 1602 bite into the attachment bar (such as attachment bar 1902 shown in FIGS. 19A-19B or any other attachment bar described herein) and creates clearance when rotating open. The geometry changes on the locking pieces 1604 make latching easier and more reliable, and also create a lip to prevent a mating spring from slipping out of place. The voids 1608 formed between the hooks 1602 and locking pieces 1604 are also more oval (or non-circular) shaped than the voids 1330 shown in FIG. 13E, for example.

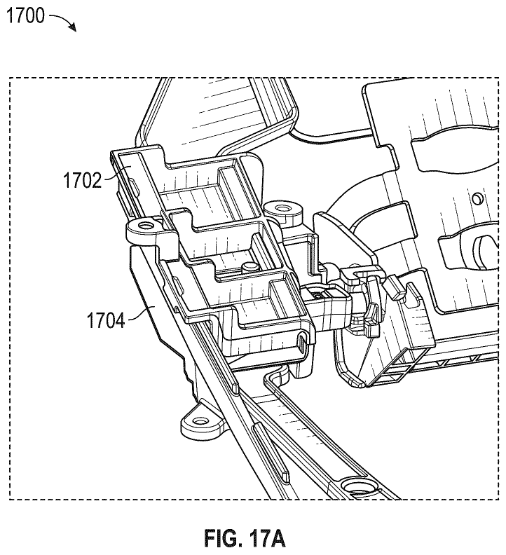

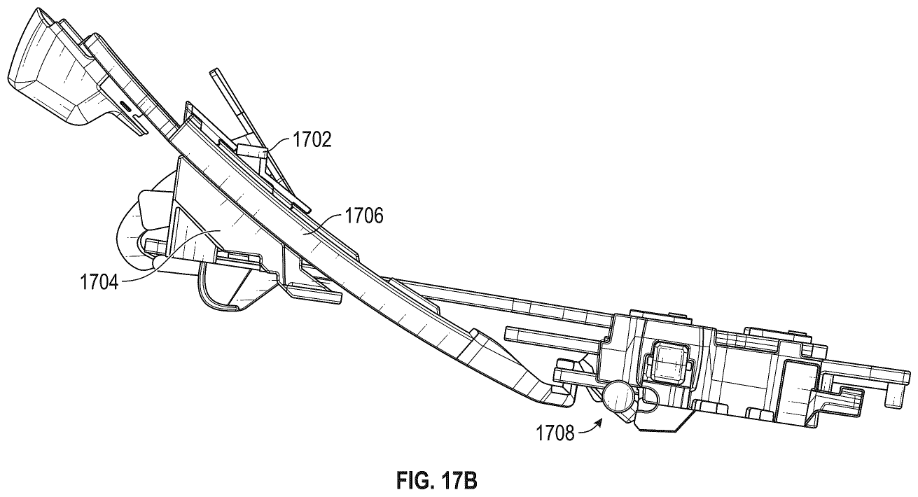

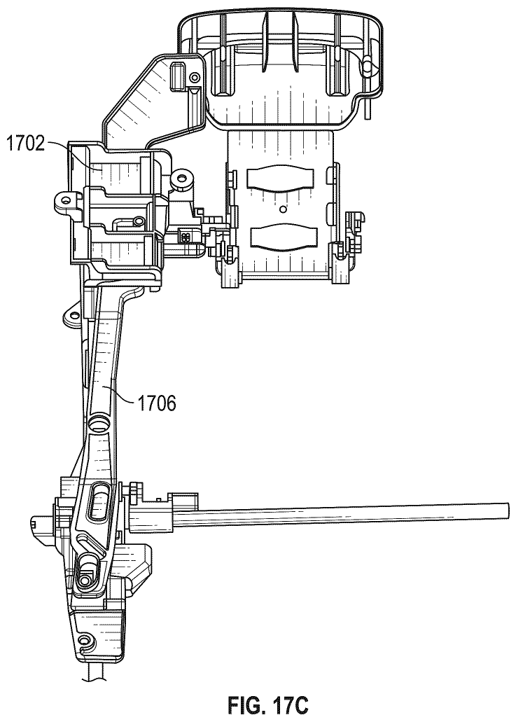

FIGS. 17A-17C show a variation of the front mechanism housings (such as front mechanism housings 1306 shown in FIGS. 13A-13B or any other like housings described herein) of the front locking mechanisms (such as front locking mechanisms 1301 shown in FIGS. 13A-13B or any other front locking mechanisms described herein). In the variation shown in FIGS. 17A-17C, the front mechanism housings (shown as front mechanism housing 1700 in FIGS. 17A-17C) are formed by combining two separate structures (a first housing structure 1702 and a second housing structure 1704), rather than being provided as a single structure. Providing the front mechanism housing 1700 as a combination of multiple, distinct structures allows for easier assembly and improves interaction with other moving parts (that is, the first housing structure 1702 and the second housing structure 1704 may be able to move relative to one another to some extent).

FIG. 17B-17C also show a variation of the front pull links (such as the front pull links 1304 shown in FIGS. 13A-13B or any other front pull links described herein). Specifically, the front pull links 1706 shown in FIGS. 17B-17C have a more curved shape to provide for a smoother movement of any other component(s) of the structure 1708 (the direction of the force is changed based on the curve in the front pull links 1706). The front pull links 1706 may also be thicker at the foot end of the carrier (or any other portion of the front pull links 1706) to increase rigidity.

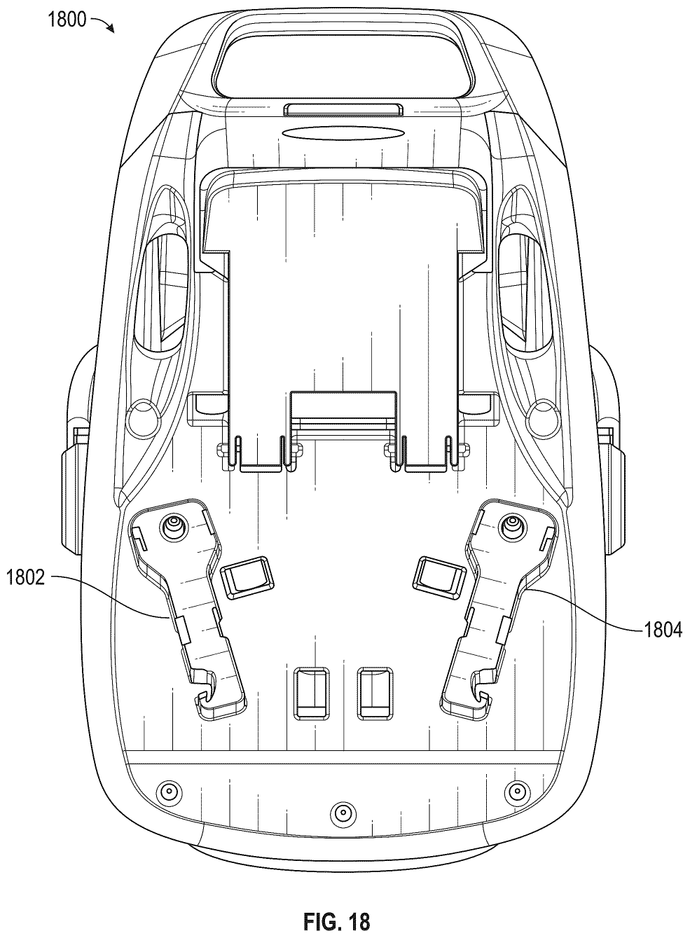

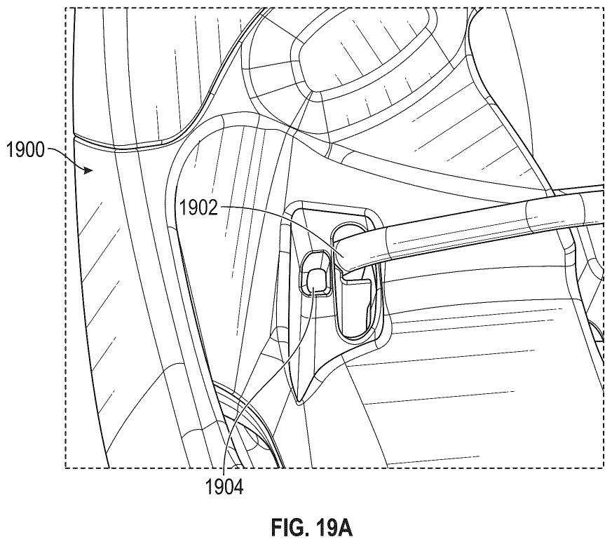

FIGS. 18-19A show variation(s) of the base. FIG. 18 shows a base 1800 (which may be the same as, or similar to, as base 1400 or any other base described herein) including storage features 1802 and 1804. For example, the storage features 1802 and 1804 may be configured to store anchors that are used to secure the base 1800 to a surface, such as a seat in a vehicle. The wider section at the top of the storage features 1802 and 1804 provides room for an adjuster of the lower anchors. The loop of plastic at the bottom of the storage features 1802 and 1804 allows the hooks on the anchors to attach and hold. The tabs along the edge of the storage features 1802 and 1804 retain the lower anchors within the storage features 1802 and 1804. The size and/or shape (and/or other properties) of the storage features 1802 and 1804 shown in FIG. 18 are merely exemplary and may vary depending on the anchors being stored within the storage features 1802 and 1804.

FIG. 19A shows a base 1900 (which may be the same as, or similar to, base 1400 or any other base described herein) that includes an indicator element 1904. The indicator element 1904 provides a visual indication of the current position of the attachment bar 1902 (which may be the same as, or similar to, attachment bar 1402 or any other attachment bar described herein) located on the base 1900. For example, the indicator element 1904 may have multiple different colored markings, where one color may be visible when the attachment bar 1902 is in one position and another color may be visible when the attachment bar 1902 is rotated to another position. That is, the indicator element 1904 may be mechanically engaged with the attachment bar 1902, such that when the attachment bar 1902 rotates, the indicator element 1904 rotates with the rotation of the attachment bar 1902. In this manner, a different portion of the indicator element 1904 of a different color is then visible after rotation (for example, when the attachment bar 1902 is in one position, the indicator element 1904 can be green, and when the attachment bar 1902 is in another position, the indicator element 1904 can be red). However, any other color combinations may also be used. Additionally, the indicator element 1904 may visually indicate the different positions of the attachment bar 1902 using a mechanism other than color, and/or the indicator element 1904 may change based on the movement of the attachment bar 1902 in any other suitable manner other than being a structure that rotates along with the rotation of the attachment bar 1902.

Additionally, FIG. 19B shows that the base 1900 may include one or more additional protruding elements 1908 and 1910 (“bumps”). These protruding elements 1908 and 1910 help to align the carrier (not shown in the figure) when it is placed in the base 1900. The protruding elements 1908 and 1910 may be any other size and/or shape (and/or there may also be any other number of such structures). The protruding elements may also be provided at any other positions on the base 1900.

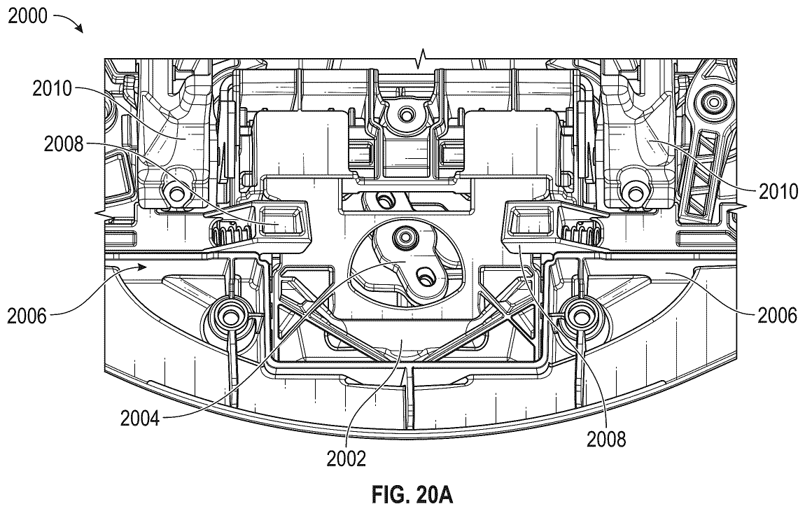

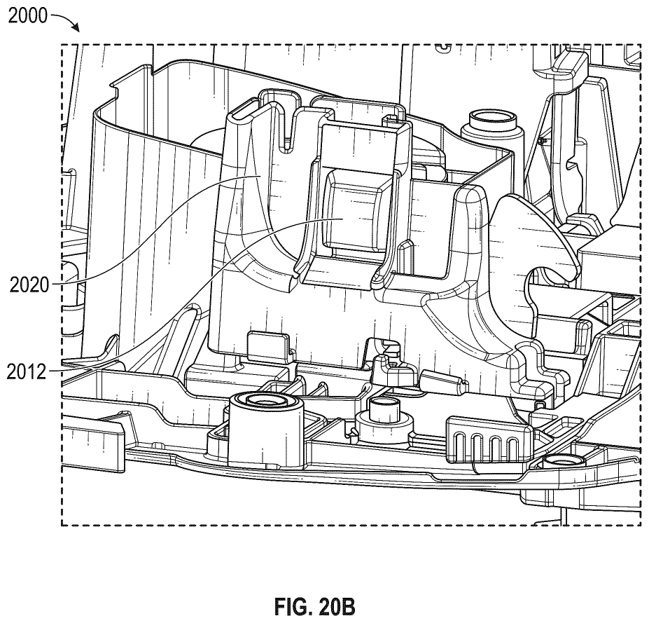

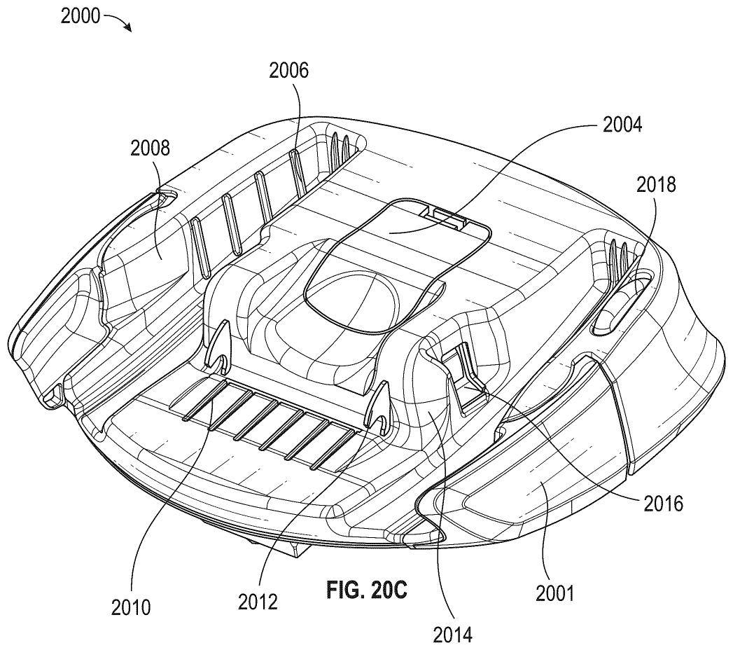

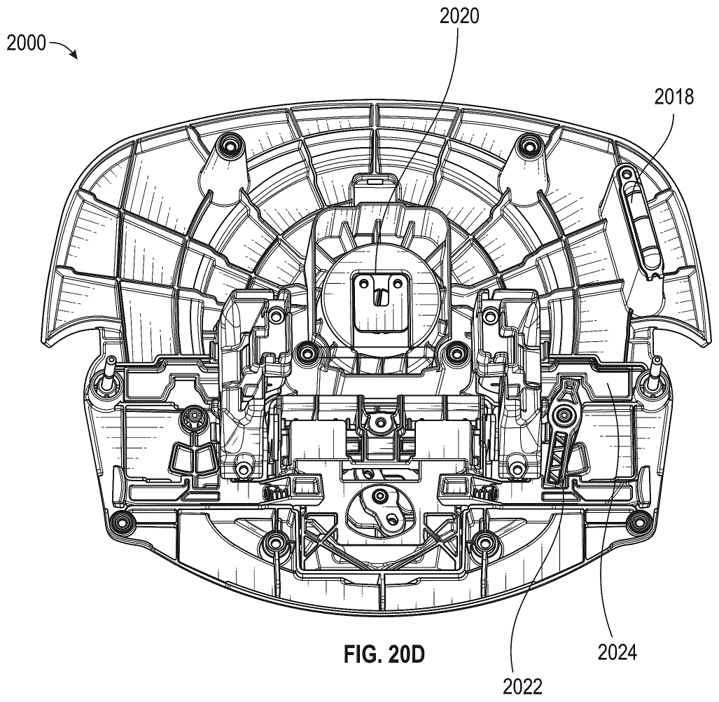

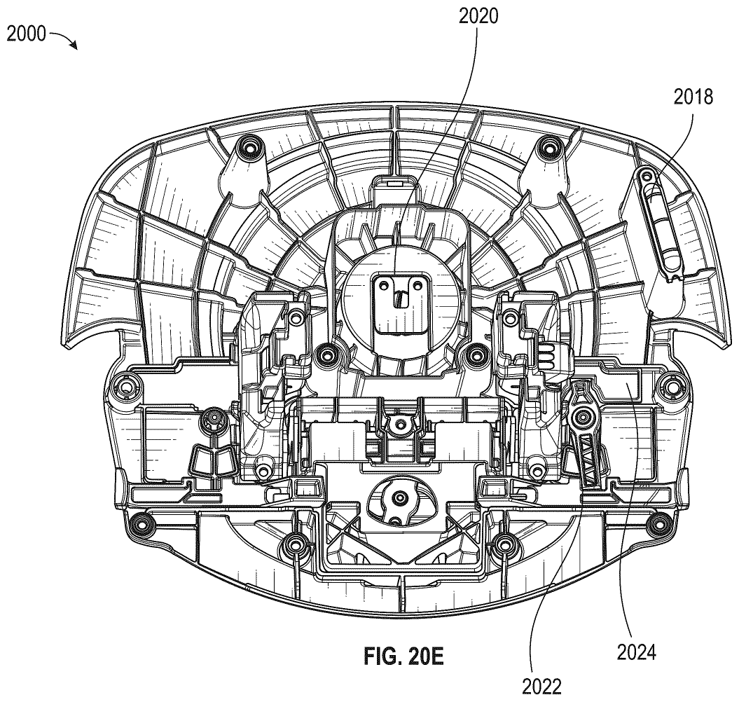

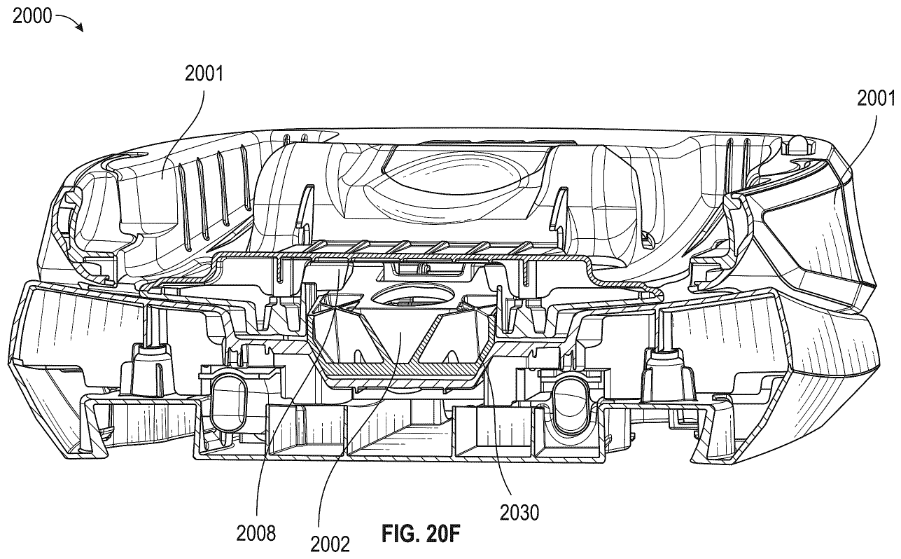

FIGS. 20A-20F show a variation of a turn table 2000 (which may be the same as, or similar to, turn tables 160, 207, 400, 600, and/or any other turn tables described herein). Beginning with FIGS. 20A-20B, these figures show the interior of the turn table 2000 in which the internal mechanisms reside (similar to how FIGS. 6A-6C show internal mechanisms of turn table 600). For example, FIG. 20A shows turn lock 2002 (which may be the same as, or similar to, turn lock 610 or any other turn lock), three-bin bar 2004 (which may be the same as, or similar to, three-pin bar 608 or any other three-pin bar), turn table pull links 2006 (which may be the same as, or similar to, turn table pull link 612 or any other turn table pull link), passthrough arm 2012 (which may be the same as, or similar to, passthrough arm 618 or any other passthrough arm). The turn table 2000 may also include any other internal mechanisms of any turn table described herein, such as shown in FIGS. 6A-6C or otherwise.

Specifically, the turn table pull links 2006 include extension structures 2008 that at least partially extend over the top of the turn lock 2002. The ramped surfaces press the turn lock 2002 back into position without allowing the turn lock 2002 to pop up without actuating the turn handle. That is, the turn table pull links 612 have a flat surface that stops against the turn lock 610, whereas the turn table pull links 2006 have the extension structures 2008 that act similarly to hooks and extend over the turn lock 2002. Additionally, the bottom of the turn lock 2002 includes ramped corners (which may be at a 45 degree angle or any other angle) in contrast with the 90 degree corners shown at the bottom part of the turn lock 610 shown in FIG. 7A. Additionally, when in the actuated position with the turn table rotated 90 degrees, then the pass through arm 2012 protrude through the 2020, as shown in FIG. 20B. This allows for the front hooks (for example, front hooks 1313 shown in FIG. 13E or any other front hooks described herein) to be reset when the carrier is slid in from the rotated position (by pressing on the carrier passthrough buttons, such as carrier passthrough buttons 316 or any other carrier passthrough buttons described herein).

FIGS. 20D and 20E show top-down full views of the internal mechanisms shown in FIG. 20A-20B. Specifically, FIG. 20D shows the internal mechanisms in an unactuated state and FIG. 20E shows the internal mechanisms in an actuated state. Specifically, FIGS. 20D-20E show one or more pass through sliders 2024, the pass through toggle 2022, the level indicator 2018 and a main axle clip 2020. The pass through toggle 2022 the pull link 2006 to the pass through slider 2024 while reversing the motion, so that it can push the pass through arm 2012 outward.

FIG. 20C shows another variation of a turn table 2000 (for example, a variation of turn table 400 shown in FIG. 4 or any other turn table). With the turn table 2000, the geometry of the handle 2001 is configured to provide a greater surface area for a user to grip. This provides improved ergonomics since the pull force required is less difficult to produce with a larger surface area of the handle 2001 (as shown in FIG. 20C). The turn table 2000 also includes a cap piece 2004 to allow for access to the center axle, which is used to assemble the turn table 2000 onto the base (not shown in the figure). Ribs 2006 are cut in the recessed area where the carrier (not shown in the figure) sits, which provides for tighter fitment. A sloped section 2008 may be included on the sides of these recessed areas to “lead-in” a stroller attachment feature (for example, stroller plungers 312 in FIG. 3A). Ribs 2010 may be included in front of the hooks 2012 to provide for more effective engagement with the carrier bar (for example, rear bar 314 in FIG. 3A). The hooks 2012 may have a curve to their top surface, which allows the hooks 2012 to ramp out of the way more smoothly. Bumps 2014 may be included just before the pass through pieces 2016 that function to actuate the carrier's pass through piece 2016 once (for example, passthrough button 316 in FIG. 3A) when sliding in the carrier from the rotated position (for example, shown in FIGS. 8C and 8D). Actuating once allows the front hooks to unlock and to be ready to accept the trapezoid bar. These bumps 2014 also serve to guide the carrier rightward (for example, shown in in FIGS. 9A and 9B) when dropping in which makes the rear bar (for example, shown in FIG. 3A) click into the turntable hooks 2012. Also included is a bubble level indicator 2018 that is used in conjunction with the recline mechanism to ensure proper seatback angle of the child occupant.

FIG. 20F shows a cross-section side view of the internal mechanisms shown in FIGS. 20A-20B and 20D-20E. FIG. 20F shows extension structures 2008 of turn table pull links 2006 that extend over the top of the turn lock 2002. The turn lock 2002 has ramped surfaces on the bottom that interact with the base 2030 (which may be the same as, or similar to, any base described herein). When turning the seat, the ramps at the bottom of the turn lock 2002 will push the turn lock 2002 up and out of the way, but the extensions of the extension structures 2008 of turn table pull links 2006 prevent that unless the actuator handles 2001 have been pulled.

Although certain product features, functions, components, and parts have been described herein in accordance with the teachings of the present disclosure, the scope of coverage of this patent is not limited thereto. On the contrary, this patent covers all embodiments of the teachings of the disclosure that fairly fall within the scope of permissible equivalents.

Unless otherwise noted, the terms used herein are to be understood according to conventional usage by those of ordinary skill in the relevant art. In addition to the definitions of terms provided below, it is to be understood that as used in the specification and in the claims, “a” or “an” may mean one or more, depending upon the context in which it is used.

Throughout this application, the term “include,” “include(s)” or “including” means “including but not limited to.” Note that certain embodiments may be described relating to a single glass, but the corresponding description should be read to include embodiments of two or more glasses. Different features, variations, and multiple different embodiments are shown and described herein with various details. What has been described in this application at times in terms of specific embodiments is done for illustrative purposes only and without the intent to limit or suggest that what has been conceived is only one particular embodiment or specific embodiments. It is to be understood that this disclosure is not limited to any single specific embodiments or enumerated variations. Many modifications, variations and other embodiments will come to mind of those skilled in the art, and which are intended to be and are in fact covered by this disclosure. It is indeed intended that the scope of this disclosure should be determined by a proper legal interpretation and construction of the disclosure, including equivalents, as understood by those of skill in the art relying upon the complete disclosure present at the time of filing.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language generally is not intended to imply that features, elements, and/or operations are in any way required for one or more implementations or that one or more implementations necessarily include logic for deciding, with or without user input or prompting, whether these features, elements, and/or operations are included or are to be performed in any particular implementation.

What has been described herein in the present specification and drawings includes examples of systems, apparatuses, methods, devices, and/or techniques. It is, of course, not possible to describe every conceivable combination of components and/or methods for purposes of describing the various elements of the disclosure, but it may be recognized that many further combinations and permutations of the disclosed elements are possible. Accordingly, it may be apparent that various modifications may be made to the disclosure without departing from the scope thereof. In addition, or as an alternative, other embodiments of the disclosure may be apparent from consideration of the specification and annexed drawings, and practice of the disclosure as presented herein. It is intended that the examples put forth in the specification and annexed drawings be considered, in all respects, as illustrative and not limiting. Although specific terms are employed herein, they are used in a generic and descriptive sense only and not for purposes of limitation.

What is claimed is:

1. A car seat comprising:
a carrier;
a base including a base body and a turn table configured to receive the carrier and rotate relative to the base body;
one or more first attachment points provided on the base body, wherein the one or more first attachment points are configured to lock the carrier in a first position; and
one or more second attachment points provided on the turn table, wherein the one or more second attachment points are configured to lock the carrier on the turn table as the turn table is rotated.

2. The car seat of claim 1, wherein the one or more first attachment points include an attachment bar provided on the base body.

3. The car seat of claim 2, wherein the carrier includes one or more first hooks, and wherein the one or more first hooks are configured to receive the attachment bar.

4. The car seat of claim 3, further comprising a first actuator configured to cause the one or more first hooks to release from the attachment bar.

5. The car seat of claim 4, wherein the one or more second attachment points include one or more second hooks provided on the turn table.

6. The car seat of claim 5, wherein the carrier includes a rear bar, and wherein the one or more second hooks are configured to automatically snap over the rear bar.

7. The car seat of claim 6, further comprising a second actuator configured to cause a rotation of the rear bar, wherein the rotation of the rear bar causes the one or more second hooks to retract from the bar and the one or more first hooks to release from the attachment bar.

8. The car seat of claim 1, wherein the turn table further comprises one or more grooves, and wherein the carrier is configured to be slid through the one or more grooves of the turn table via one or more carrier rails.

9. A car seat comprising:
a carrier; and
a base including a base body and a turn table configured to receive the carrier and rotate relative to the base body, wherein the turn table includes one or more grooves, and wherein the carrier is configured to be slid through the one or more grooves of the turn table via one or more carrier rails.

10. The car seat of claim 9, further comprising:
one or more first attachment points provided on the base body, wherein the one or more first attachment points are configured to lock the carrier in a first position.

11. The car seat of claim 10, wherein the one or more first attachment points include an attachment bar provided on the base body.

12. The car seat of claim 11, wherein the carrier includes one or more first hooks, and wherein the one or more first hooks are configured to receive the attachment bar.

13. The car seat of claim 12, further comprising a first actuator configured to cause the one or more first hooks to release the attachment bar.

14. The car seat of claim 13, further comprising:
one or more second attachment points provided on the turn table, wherein the one or more second attachment points are configured to lock the carrier on the turn table as the turn table is rotated.

15. The car seat of claim 14, wherein the one or more second attachment points include one or more second hooks provided on the turn table.

16. The car seat of claim 15, wherein the carrier includes a rear bar, and wherein the one or more second hooks are configured to automatically snap over the rear bar.

17. The car seat of claim 16, further comprising a second actuator configured to cause a rotation of the rear bar, wherein the rotation of the rear bar causes the one or more second hooks to retract from the rear bar and the one or more first hooks to release from the attachment bar.

18. A car seat comprising:
a carrier;
a base including a base body and a turn table configured to receive the carrier and rotate relative to the base body; and
at least one of: (1) one or more first attachment points provided on the base body, wherein the one or more first attachment points are configured to lock the carrier in a first position or (2) one or more second attachment points provided on the turn table, wherein the one or more second attachment points are configured to lock the carrier on the turn table as the turn table is rotated.

19. The car seat of claim 1, wherein the one or more first attachment points include an attachment bar provided on the base body, wherein the carrier includes one or more first hooks, and wherein the one or more first hooks are configured to receive the attachment bar.

20. The car seat of claim 1, wherein the one or more second attachment points include one or more second hooks provided on the turn table, wherein the carrier includes a rear bar, and wherein the one or more second hooks are configured to automatically snap over the rear bar.
